(19) United States
(12) Patent Application Publication
(10) Pub. No.: US 2023/0393925 A1
(43) Pub. Date: Dec. 7, 2023

(54) FAILURE HANDLING SUPPORT APPARATUS AND METHOD

(71) Applicant: Hitachi, Ltd., Tokyo (JP)

(72) Inventor: Masakazu TOKUNAGA, Tokyo (JP)

(21) Appl. No.: 18/116,477

(22) Filed: Mar. 2, 2023

(30) Foreign Application Priority Data
Jun. 7, 2022 (JP) 2022-092193

(51) Int. Cl. G06F 11/07

(52) U.S. Cl. CPC G06F 11/079; G06F 11/0709; G06F 11/0751

(57) ABSTRACT

Proposed are a failure handling support apparatus and method capable of optimizing maintenance work by promptly presenting to a maintenance worker the objective urgency and priority of recovery measures to be taken for handling a failure that occurred in a system being used by numerous users. Status monitoring of a network and server devices is performed, and, when a failure is detected in the status monitoring, an urgency of handling the failure is calculated based on whether there has been any access from a user from an occurrence of the failure up until now, a priority of the failure is determined based on the calculated urgency, and a determination result of the priority is presented to the maintenance worker.

### TECHNICAL FIELD

The present invention relates to a failure handling support apparatus and method and, for example, can be suitably applied to a failure handling support apparatus for supporting the measures to be taken by a maintenance worker for handling a failure that occurred in a system.

### BACKGROUND ART

If a failure occurs in an important system, it is necessary to quickly comprehend the influence of the failure and promptly take measures to handle the failure. If a plurality of failures occurs simultaneously, a maintenance worker needs to give consideration to the urgency and priority of the recovery measures to be taken for handling the failures.

With respect to this point, for example, PTL 1 discloses a mode of determining an urgency of each plant unit from a warning classification of a unit integration database, evaluating an influence that the event will have on other plant units based on the unit integration database and an inter-unit influence evaluation database, and determining a priority between the respective plant units from the urgency determined for each plant unit and the influence determined for each plant unit.

Moreover, the PTL 2 discloses grouping information for identifying sites where each of a plurality of devices is installed and failure history information related to an occurrence of an indication of a failure in a corresponding device and the failure that occurred in that device after the indication by classifying the information based on characteristic information indicating characteristics of the site, calculating a failure probability, for each formed group, which changes pursuant to an elapsed time from the occurrence of the indication to the occurrence of the failure, storing the failure probability calculated for each group, acquiring a travel time from a maintenance worker's base to the sites where the respective devices in which the indication occurred are installed, calculating a failure probability at the time that the maintenance worker will reach the sites where the respective devices in which the indication occurred are installed based on the stored failure probability and the acquired travel time, and setting a priority of performing maintenance inspection to the respective devices in which the indication occurred based on the calculated failure probability.

### CITATION LIST

### Patent Literature

[PTL 1] Domestic Re-publication of PCT International Application No. 2016-63374

[PTL 2] Japanese Unexamined Patent Application Publication No. 2015-169989

### SUMMARY OF THE INVENTION

### Problems to be Solved by the Invention

Nevertheless, the urgency and priority disclosed in PTL 1 and PTL 2 are not the urgency and priority from the perspective of the users using the system. Thus, for example, even if the technologies disclosed in PTL 1 and PTL 2 are applied to a system used by many people, if a plurality of failures occurs simultaneously, there is a problem in that it is still necessary for the maintenance worker to determine the priority of measures to be taken for handling these failures in light of the degree of influence that the failures will have on the users.

The present invention was devised in view of the foregoing points, and an object of this invention is to propose a failure handling support apparatus and method capable of optimizing maintenance work by promptly presenting to a maintenance worker the objective urgency and priority of recovery measures to be taken for handling a failure that occurred in a system being used by numerous users.

### Means to Solve the Problems

In order to achieve the foregoing object, the present invention provides a failure handling support apparatus which supports failure handling by a maintenance worker, comprising: a status monitoring unit which performs status monitoring of a network and server devices; an urgency calculation unit which calculates, when the status monitoring unit detects a failure, an urgency of handling the failure based on whether there has been any access from a user from an occurrence of the failure up until now; a priority determination unit which determines a priority of the failure based on the urgency calculated by the urgency calculation unit; and a determination result presentation unit which presents a determination result of the priority determination unit to the maintenance worker.

Moreover, the the present invention provides a failure handling support method to be executed by a failure handling support apparatus which supports failure handling by a maintenance worker, comprising: a first step of performing status monitoring of a network and server devices; a second step of calculating, when a failure is detected in the status monitoring, an urgency of handling the failure based on whether there has been any access from a user from an occurrence of the failure up until now; a third step of determining a priority of the failure based on the calculated urgency; and a fourth step of presenting a determination result of the priority to the maintenance worker.

According to the failure handling support apparatus and method of the present invention, it is possible to promptly present to the maintenance worker the objective urgency and priority of a failure that occurred in a system being used by numerous users.

### Advantageous Effects of the Invention

According to the present invention, it is possible to realize a failure handling support apparatus and method capable of optimizing maintenance work.

### BRIEF DESCRIPTION OF DRAWINGS

FIG. 1 is a block diagram showing a schematic configuration of the information processing system according to this embodiment.

FIG. 2 is a block diagram showing a configuration of the service server, the external connection server and the monitoring server.

FIG. 3 is a diagram showing a configuration example of the access history table.

FIG. 4 is a diagram showing a configuration example of the network monitoring table.

FIG. 5 is a diagram showing a configuration example of the response threshold table.

FIG. 6 is a diagram explaining the output information of the performance monitoring manager program.

FIG. 7 is a diagram showing a configuration of the failure management table.

FIG. 8 is a diagram showing a configuration example of the urgency table.

FIG. 9 is a diagram showing a configuration example of the importance table.

FIG. 10 is a diagram showing a configuration example of the configuration management table.

FIG. 11 is a diagram showing a configuration example of the maintenance hours table.

FIG. 12 is a diagram showing a configuration example of the setting table.

FIG. 13 is a diagram showing a screen configuration example of the failure occurrence status list screen.

FIG. 14 is a flowchart showing a processing routine of the access monitoring processing.

FIG. 15A is a flowchart showing a processing routine of the network monitoring processing.

FIG. 15B is a flowchart showing a processing routine of the network monitoring processing.

FIG. 16 is a flowchart showing a processing routine of the status monitoring processing.

FIG. 17A is a flowchart showing a processing routine of the urgency calculation processing.

FIG. 17B is a flowchart showing a processing routine of the urgency calculation processing.

FIG. 18A is a flowchart showing a processing routine of the priority determination processing.

FIG. 18B is a flowchart showing a processing routine of the priority determination processing.

FIG. 19 is a diagram explaining the elapsed time coefficient.

FIG. 20 is a flowchart showing a processing routine of the determination result presentation processing.

FIG. 21 is a flowchart showing a processing routine of the handled check processing.

### DESCRIPTION OF EMBODIMENTS

An embodiment of the present invention is now explained in detail with reference to the appended drawings.

### (1) Configuration of Information Processing System According to this Embodiment

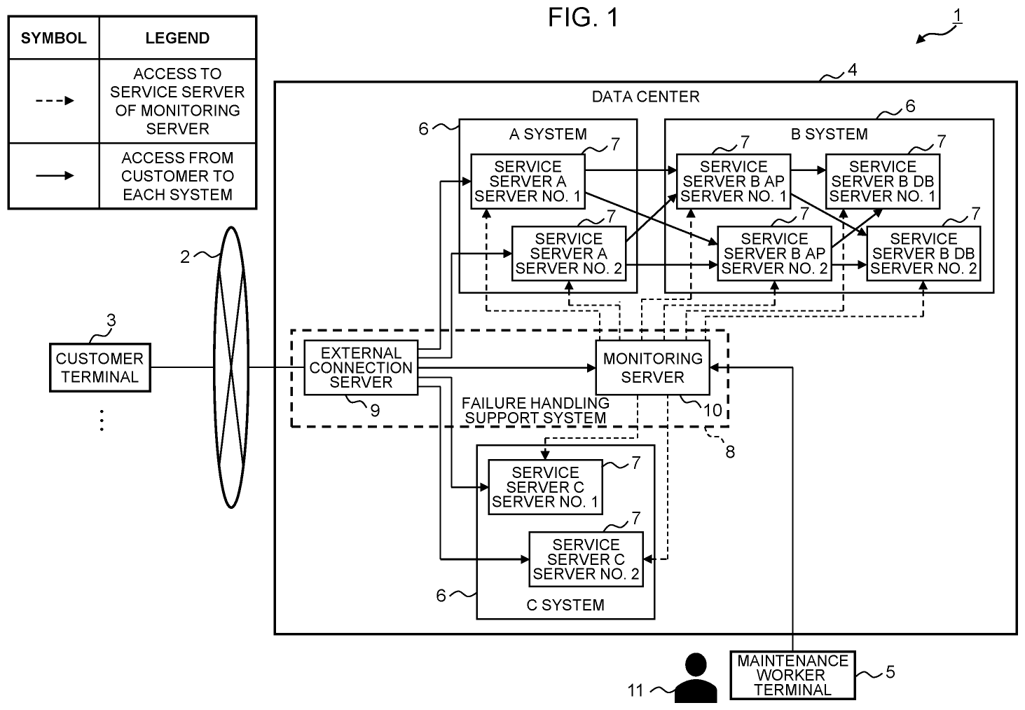

In FIG. 1, reference numeral 1 shows the overall information processing system according to this embodiment. The information processing system 1 is configured by comprising one or more customer terminals 3 and a data center 4 mutually connected via a network 2, and a maintenance worker terminal 5.

The customer terminal 3 is a general-purpose computer device provided to a customer using the data center 4, and sends a request to the data center 4 via the network 2 according to the customer's operation or a demand from the program.

The data center 4 is configured by comprising a plurality of service servers 7 each configuring one of the systems 6, and an external connection server 9 and a monitoring server 10 configuring a failure handling support system 8.

Each service server 7 is a server device with a function of providing some kind of service to the customers. FIG. 1 illustrates an example where a service server 7 which configures the system 6 called the “A system” and provides a service to the customers according to the system 6 (“service server A”), a service server 7 which configures the system 6 called the “B system” and provides a service to the customers according to the system 6 (“service server B”), and a service server 7 which configures the system 6 called the “C system” and provides a service to the customers according to the system 6 (“service server C”) are provided in the data center 4.

Note that FIG. 1 is a configuration example in a case where the service server 7 called the “service server B AP” in which its usage is an application server and the service server 7 called the “service server B DB” in which its usage is a database server are provided to the system 6 called the “B system”. Moreover, in FIG. 1, when the service servers 7 of the same usage configuring the same system 6 are made redundant, the service server 7 of the currently used system in a status with no failure is displayed as “server No. 1”, and the service server 7 of the standby system is displayed as “server No. 2”. And when a failure occurs, the status of the service server 7 of “server No. 2” is switched to the currently used system.

The service server 7 processes a request from the customer terminal 3, which was transferred from the external connection server 9 as described later, or sends the processing result to the next stage service server 7, and sends the request to the transmission source customer terminal 3 via the external connection server 9. FIG. 1 illustrates an example where the “service server A” of “server No. 1” or “server No. 2” of the currently used system configuring the “A system” sends the processing result of the request from the customer terminal 3 to the “service server B AP” of “server No. 1” or “server No. 2” of the currently used system configuring the “B system”, and the “service server B AP”, after processing the request by using the “service server B DB”, sends the processing result thereof to the customer terminal 3 as the transmission source of the request via the external connection server 9. Moreover, in FIG. 1, the “service server C” of the currently used system configuring the “C system” also sends the processing result thereof to the customer terminal 3 as the transmission source of the request via the external connection server 9.

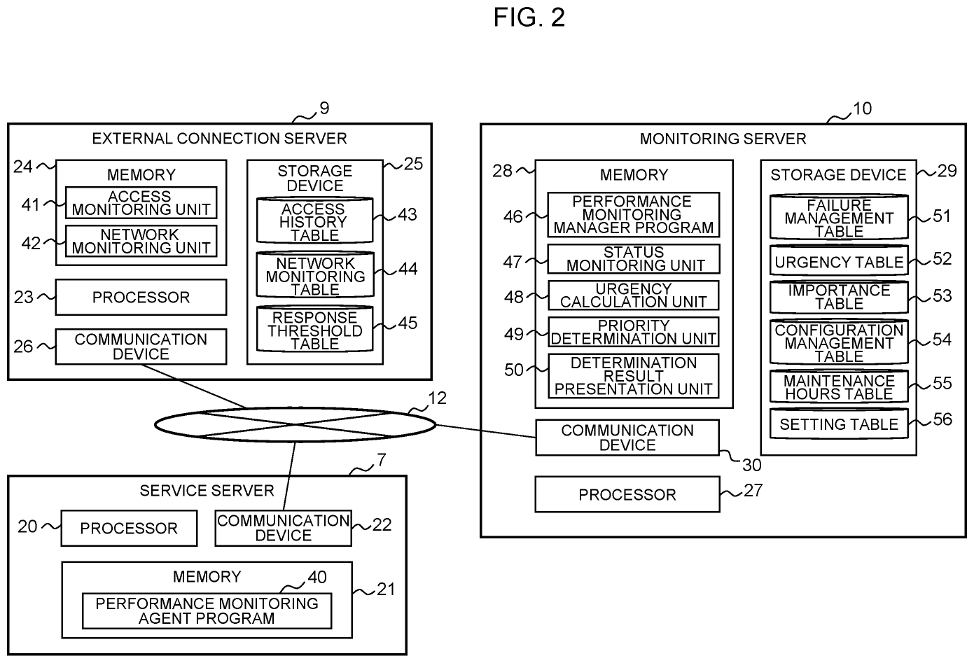

The external connection server 9 is a server device with a function of transferring the request sent from the customer terminal 3 to the corresponding service server 7 via the network 2, or monitoring the network status (communication state) between the respective service servers 7 in the data center 4. Moreover, the monitoring server 10 is a server device with a function of monitoring the status of each service server 7. The external connection server 9 and the monitoring server 10 are respectively connected to each service server 7 in the data center 4 via the data center internal network 12 (FIG. 2).

The maintenance worker terminal 5 is a general-purpose computer device or a tablet used by a maintenance worker 11 for the maintenance and management of the monitoring server 10. The maintenance worker terminal 5 updates the setting of the monitoring server 10 or provides necessary information to the monitoring server 10 by sending commands or information according to the operation performed by the maintenance worker 11 to the monitoring server 10.

FIG. 2 shows a specific configuration example of the service server 7, the external connection server 9 and the monitoring server 10. As shown in FIG. 2, the service server 7 is configured from a general-purpose server device comprising information processing resources such as a processor 20, a memory 21 and a communication device 22.

The processor 20 is a control device that governs the operational control of the overall service server 7. Moreover, the memory 21 is configured, for example, from a semiconductor memory and stores various programs, and is also used as a work memory of the processor 20. The communication device 22 is configured, for example, from an NIC (Network Interface Card) and performs protocol control during the communication with the external connection server 9 or the monitoring server 10 via the data center internal network 12.

Moreover, the external connection server 9 is configured from a general-purpose server device comprising information processing resources such as a processor 23, a memory 24, a storage device 25 and a communication device 26. Since the processor 23, the memory 24 and the communication device 26 have the same configuration and functions as the processor 20, the memory 21 and the communication device 22 of the service server 7, the explanation thereof is omitted. The storage device 25 is configured from a non-volatile, large-capacity storage device such as a hard disk device or an SSD (Solid State Drive), and stores various types of data that needs to be stored for a long period.

The monitoring server 10 is also configured from a general-purpose server device comprising information processing resources such as a processor 27, a memory 28, a storage device 29 and a communication device 30. Since the processor 27, the memory 28 and the communication device 30 have the same configuration and functions as the processor 20, the memory 21 and the communication device 22 of the service server 7, and since the storage device 29 also has the same configuration and functions as the storage device 25 of the external connection server 9, the explanation thereof is omitted.

### (2) Failure Handling Support Function

The failure handling support function according to this embodiment equipped in the failure handling support system 8 (FIG. 1) configured from the external connection server 9 and the monitoring server 10 is now explained. The failure handling support function is a function of monitoring the status of the service server 7 to be monitored in the data center 4 and the status of the data center internal network 12, and, if a failure of the service server 7 or the data center internal network 12 is detected, calculating a priority of the recovery measures to be taken for handling each of the detected failures and presenting the calculation result to the maintenance worker 11.

In effect, in the failure handling support system 8, the external connection server 9 monitors the status of the data center internal network 12 between the external connection server 9 and each service server 7, and the monitoring server 10 is monitoring the status of each service server 7 to be monitored in the data center 4.

When the monitoring server 10 detects a failure of any service server 7 or the external connection server 9 detects a failure of the data center internal network 12, the monitoring server 10 calculates an urgency of the recovery measures to be taken for handling the failure based on whether a recovery from the failure has been achieved, whether switching to a standby system has been performed, and whether there has been any access from the customer terminal 3 from the occurrence of the failure up until now.

Moreover, the monitoring server 10 calculates a priority of the recovery measures to be taken for handling each failure based on the calculated urgency, the importance of the system 6 configured from the service server 7 in which the failure occurred, and the elapsed time from the occurrence of the failure, sorts the failure information of each failure in order according to the calculated priority, and displays it as a list. By displaying the failure information of each failure in order according to the calculated priority as described above, failures with high urgency and failures of the system 6 of high importance can be objectively recognized, and the maintenance worker 11 can thereby handle the failures in order from a failure of high priority.

As a means for realizing this kind of failure handling support function, as shown in FIG. 2, a performance monitoring agent program 40 is stored in the memory 21 of the service server 7. Moreover, an access monitoring unit 41 and a network monitoring unit 42 are stored in the memory 24 of the external connection server 9, and an access history table 43, a network monitoring table 44 and a response threshold table 45 are stored in the storage device 25 of the external connection server 9.

Furthermore, as a means for realizing the failure handling support function, a performance monitoring manager program 46, a status monitoring unit 47, an urgency calculation unit 48, a priority determination unit 49 and a determination result presentation unit 50 are stored in the memory 28 of the monitoring server 10, and a failure management table 51, an urgency table 52, an importance table 53, a configuration management table 54, a maintenance hours table 55 and a setting table 56 are stored in the storage device 29 of the monitoring server 10.

The performance monitoring agent program 40 of each service server 7 is a program with a function of collecting resource information such as the operating rate of the processor 20 in the service server 7 in which it is installed, usage rate of the memory 21 and usage rate of the storage device (not shown), and information such as various logs and the operating status of each process. The performance monitoring agent program 40 monitors the status of each resource, contents of each log, and status of each process based on the collected information.

Moreover, the access monitoring unit 41 of the external connection server 9 is a program with a function of monitoring access from the customer terminal 3 (FIG. 1) to the service server 7 in the data center 4. Each time that there is an access from the customer terminal 3 to the service server 7 (each time that a request is sent to the service server 7), the access monitoring unit 41 collects information such as the date/time of the access, system name of the system 6 (FIG. 1) configured from the service server 7 as the access destination, and response time from the service server 7 in response to the access, stores the information in the access history table 43, and thereby manages the information.

The network monitoring unit 42 is a program with a function of monitoring the status of the data center internal network 12 which respectively connects the external connection server 9 and each service server 7. The network monitoring unit 42 confirms the status of the data center internal network 12 between the external connection server 9 and each service server 7 by periodically (for instance, one-minute cycle) sending a request for measuring the response time (this is hereinafter referred to as the “response time measurement request”) to each service server 7 to be monitored, stores the confirmation results in the network monitoring table 44, and thereby manages the confirmation results.

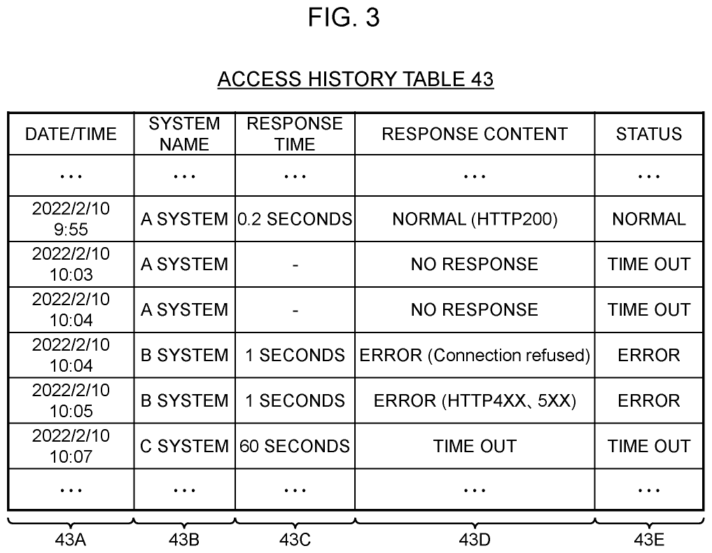

The access history table 43 is a table that is used for storing and retaining history information related to the accesses from the customer terminal 3 to the service server 7 in the data center 4 via the network 2 (FIG. 1) as described above, and is configured by comprising, as shown in FIG. 3, a date/time column 43A, a system name column 43B, a response time column 43C, a response content column 43D and a status column 43E. In the access history table 43, one entry (line) corresponds to history information of one access from one of the customer terminals 3 to one of the service servers 7 in the data center 4.

The date/time column 43A stores the date/time of the corresponding access, and the system name column 43B stores the name (system name) of the system 6 configured from the service server 7 that was accessed. Moreover, the response time column 43C stores the time (response time) until the external connection server 9 receives a response after transferring the request of the corresponding access to the corresponding service server 7.

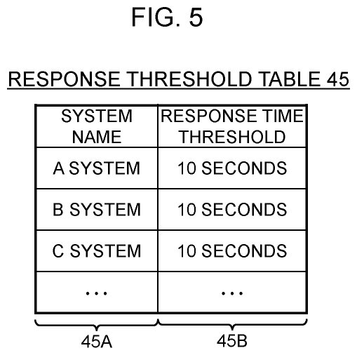

Furthermore, the response content column 43D stores the content of the response (response content). Moreover, the status column 43E stores the status of the response (response status) determined from the response content. Note that, as the response status, there are, for example, “normal” in which the response was received normally, “time out” in which the response could not be received by the response time threshold described later with reference to FIG. 5, and “error” in which the response was obtained but contained an error.

Accordingly, FIG. 3 illustrates a case where, for example, there was an access to the “A system” at “2022/2/10 9:55”, the response time from the “A system” in response to the access was “0.2 seconds”, the response content was “normal (HTTP200)”, and the response status was “normal”. The network monitoring table 44 is a table that is used for storing and retaining the status of the data center internal network 12 between the external connection server 9 and each service server 7 which was acquired by the network monitoring unit 42 periodically sending a response time measurement request to each service server 7 to be monitored in the data center 4 via the data center internal network 12 as described above.

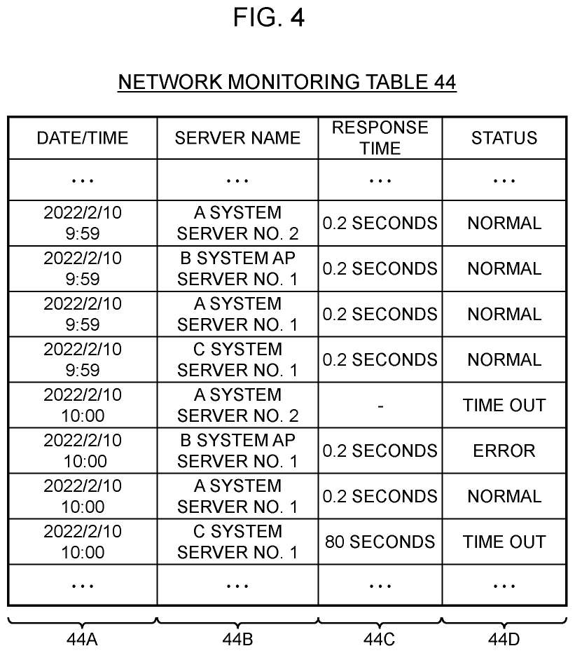

The network monitoring table 44 is configured by comprising, as shown in FIG. 4, a date/time column 44A, a server name column 44B, a response time column 44C and a status column 44D. In the network monitoring table 44, one entry (line) corresponds to information representing the status of the data center internal network 12 between the external connection server 9 and one service server 7 to be monitored in the data center 4 which was acquired by the external connection server 9 sending a response time measurement request to the corresponding service server 7.

The date/time column 44A stores the date/time that the external connection server 9 sent one response time measurement request to one of the service servers 7, and the server name column 44B stores the name (server name) of the corresponding service server 7. FIG. 4 illustrates a case where a combination of the system name of the system 6 configured from the corresponding service server 7, the usage of the corresponding service server 7 (only when there is a service server 7 with a different usage in the same system 6), and the server number of the corresponding service server 7 in the corresponding system 6 are being used as the server name of the corresponding service server 7.

Moreover, the response time column 44C stores the time (response time) until the external connection server 9 receives a response after sending a response time measurement request to the corresponding service server 7. Note that, when a time out described later occurs, the response time column 44C stores information (“−” in FIG. 4) representing that there is no information.

Furthermore, the status column 44D stores the status of the data center internal network 12 of the external connection server 9 and the corresponding service server 7 which is estimated from the response time. As the “status of the data center internal network 12”, there are, for example, “normal” in which the data center internal network 12 is of a normal status, “time out” in which the response could not be received by a prescribed time (response time threshold described later with reference to FIG. 5) due to disconnection or congestion, and “error” in which the response was received but the content thereof was an error.

Accordingly, FIG. 4 illustrates a case where a response time measurement request was sent to the service server 7 called the “A system server No. 2” at “2022/2/10 9:59”, there was a response from the corresponding service server 7 “0.2 seconds” thereafter, and the status of the data center internal network 12 between the external connection server 9 and the corresponding service server 7 was determined to be “normal”. Note that the network monitoring table 44 constantly retains information related to the status of the data center internal network 12 between the external connection server 9 and each service server 7 at least for the most recent two cycles.

The response threshold table 45 is a table that is used for managing the temporal threshold pre-set for each system which is used for determining a time out when a request or a response time measurement request is sent to the service server 7 of the corresponding system 6 (this is the response time that becomes a time out when the response time exceeds this threshold; hereinafter referred to as the “response time threshold”). The response threshold table 45 is configured by comprising, as shown in FIG. 5, a system name column 45A and a response time threshold column 45B. In the response threshold table 45, one entry (line) corresponds to one system 6.

The system name column 45A stores the system name of the corresponding system 6, and the response time threshold column 45B stores the response time threshold that was pre-set for the corresponding system 6. Accordingly, FIG. 5 illustrates a case where the response time threshold of the “A system” has been set to “10 seconds”, and, when the external connection server 9 sends a request or a response time measurement request to the service server 7 configuring the “A system”, it is determined that a time out has occurred when the external connection server 9 could not receive a response from the corresponding service server 7 within “10 seconds”.

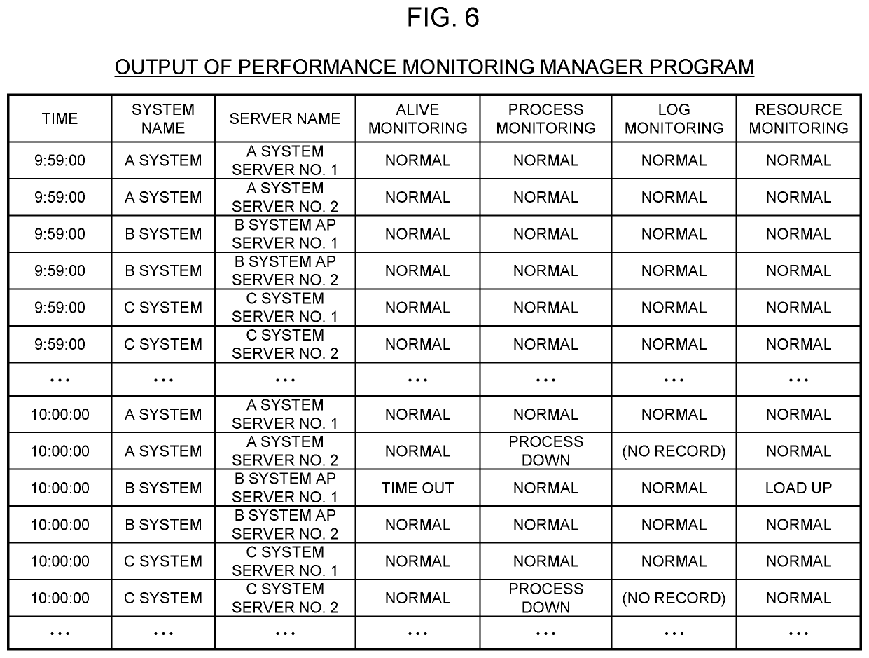

Meanwhile, the performance monitoring manager program 46 of the monitoring server 10 is a program with a function of periodically collecting, from the performance monitoring agent program 40, the monitoring result of the respective resources, respective logs and respective processes of the corresponding service server 7 acquired by the performance monitoring agent program 40 installed in each service server 7 to be monitored. The performance monitoring manager program 46 outputs, as shown in FIG. 6, information of at least the most recent two cycles among the collected information to the status monitoring unit 47 as the performance information of each service server 7.

Note that, as also evident from FIG. 6, the performance information includes the time that the performance monitoring manager program 46 collected the corresponding performance information from the corresponding performance monitoring agent program 40 (“time”), server name of the service server 7 installed with the corresponding performance monitoring agent program 40 (“server name”), system name of the system 6 configured from the corresponding service server 7 (“system name”), respective monitoring results of processes, logs and resources of the corresponding service server 7 acquired by the performance monitoring agent program 40 (“process monitoring”, “log monitoring” and “resource monitoring”), and monitoring result of the alive monitoring of the corresponding service server 7 (“alive monitoring”).

“Alive monitoring” is information added by the performance monitoring manager program 46, and is information representing whether the corresponding service server 7 is of a normal status or a down status. The performance monitoring manager program 46 sets “alive monitoring” to “normal” when it was possible to properly collect the various monitoring results described above from the performance monitoring agent program 40. Moreover, the performance monitoring manager program 46 sets “alive monitoring” to “time out” if a time out occurs in the communication with the performance monitoring agent program 40, and sets “alive monitoring” to “error” if, even though a time out did not occur, it was not possible to properly collect the various monitoring results.

The status monitoring unit 47 is a program with a function of monitoring the status of each service server 7 based on the performance information of the corresponding service server 7 provided by the performance monitoring manager program 46. When the status monitoring unit 47 detects a failure of any service server 7 based on the monitoring, the status monitoring unit 47 stores information related to the failure as failure information in the failure management table 51.

The urgency calculation unit 48 is a program with a function of calculating an urgency of the recovery measures to be taken for handling the failure for each service server 7 in which a failure occurred (this is hereinafter referred to as the “failed service server 7”) by referring to each piece of failure information stored in the failure management table 51, and the urgency table 52 described later. The urgency calculation unit 48 outputs the urgency calculated for each failed service server 7 to the priority determination unit 49.

The priority determination unit 49 is a program with a function of calculating a priority of the recovery measures to be taken for each failed service server 7 based on the urgency of each failed service server 7 notified from the urgency calculation unit 48, the importance of each system 6 pre-defined and registered in the importance table 53, and the elapsed time from the time that the failure occurred in the failed service server 7. The priority determination unit 49 outputs the priority calculated for each failed service server 7 to the determination result presentation unit 50.

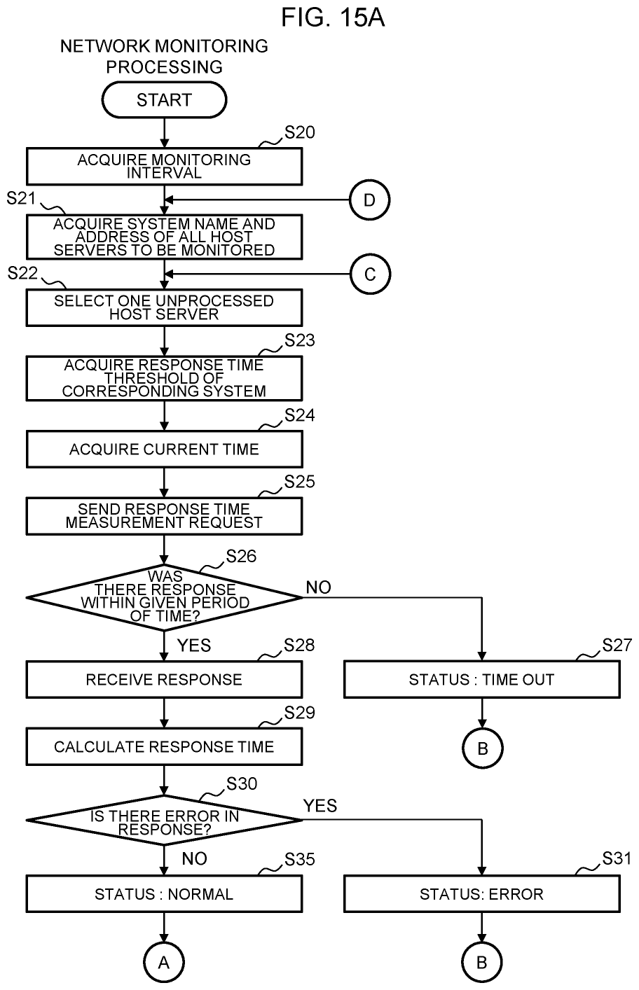

The determination result presentation unit 50 is a program with a function of generating the failure occurrence status list screen 60 described later with reference to FIG. 13 which displays the failure information of the failed service server 7 in which a failure occurred within a given period (for instance, most recent one-week or two-week period). The determination result presentation unit 50 generates the failure occurrence status list screen 60 in response to the failure occurrence status list display request sent from the maintenance worker terminal 5 (FIG. 1) according to the operation performed by the maintenance worker 11 (FIG. 1), and displays the failure occurrence status list screen 60 on the maintenance worker terminal 5 by sending the screen data thereof to the maintenance worker terminal 5 as the transmission source of the failure occurrence status list display request.

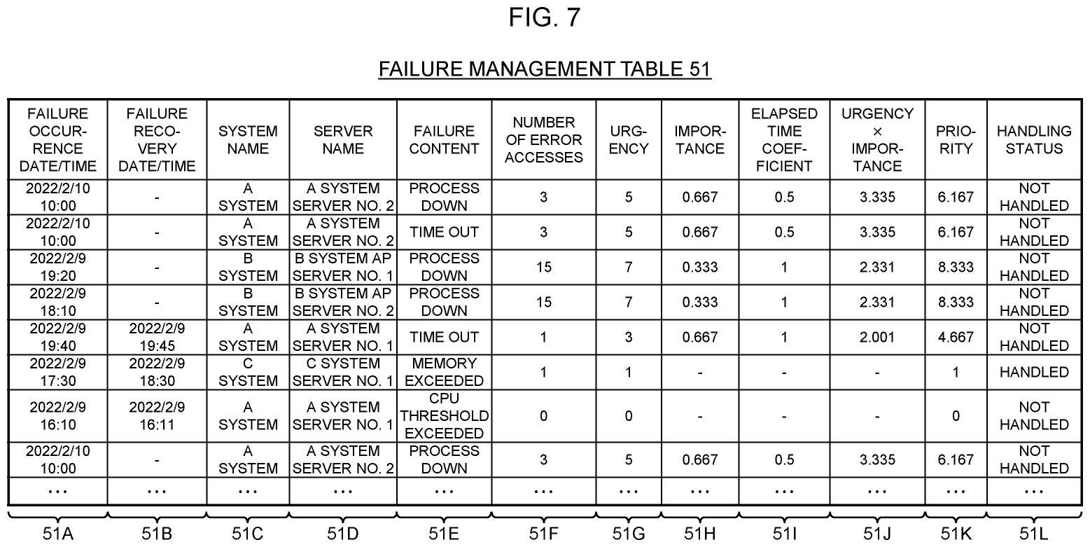

Meanwhile, the failure management table 51 is a table that is used by the status monitoring unit 47 for storing information related to a failure (this is hereinafter referred to as the “failure information”) of the service server (failed service server) 7 in which the occurrence of such failure has been determined as described above. The failure management table 51 is configured by comprising, as shown in FIG. 7, a failure occurrence date/time column 51A, a failure recovery date/time column 51B, a system name column 51C, a server name column 51D, a failure content column 51E, a number of error accesses column 51F, an urgency column 51G, an importance column 51H, an elapsed time coefficient column 511, an urgency×importance column 51J, a priority column 51K and a handling status column 51L. In the failure management table 51, one entry (line) corresponds to the failure information of one failure of one failed service server 7.

The failure occurrence date/time column 51A stores the date/time that the corresponding failure occurred, and the failure recovery date/time column 51B stores, when the corresponding failed service server 7 is recovering from its failure, the date/time that the corresponding failed service server 7 recovered from the failure. Moreover, the server name column 51D stores the server name of the corresponding failed service server 7, and the system name column 51C stores the system name of the system 6 configured from the corresponding failed service server 7.

The failure content column 51E stores the content of the corresponding failure, and the number of error accesses column 51F stores the number of times that the customer terminal 3 accessed the corresponding failed service server 7 during the period from the time that the failure occurred in the corresponding failed service server 7 up until now (when the corresponding failed service server 7 is recovering from the failure, up to the time of its recovery).

Moreover, the urgency column 51G stores the urgency of the recovery measures to be taken for handling the failure calculated by the urgency calculation unit 48, and the importance column 51H stores the information pre-set for the system 6 configured from the corresponding failed service server 7. Moreover, the elapsed time coefficient column 51I stores the elapsed time coefficient described later which was calculated regarding the elapsed time from the occurrence of the corresponding failure up until now, and the urgency×importance column 51J stores the multiplication result of the urgency of the recovery measures to be taken for handling the failure and the importance of the corresponding system 6.

Furthermore, the priority column 51K stores the priority of the recovery measures to be taken for handling the corresponding failure which was calculated by the priority determination unit 49 (FIG. 2), and the handling status column 51L stores information representing whether the corresponding failure has not been handled or has been handled. For example, when the corresponding failure has not yet been handled, “not handled” is stored in the handling status column 51L, and when the corresponding failure has already been handled, “handled” is stored in the handling status column 51L.

Accordingly, FIG. 7 illustrates a case where, for example, “process down” occurred in the service server 7 called the “A system server No. 2” configuring the “A system” at “2022/2/10 10:00”, and, since the failure has not yet been handled (value of the handling status column 51L is “not handled”), the “A system server No. 2” has not yet been recovered (failure recovery date/time column is “−”), and the customer terminal 3 accessed the “A system server No. 2” three times from the occurrence of the failure up until now. Moreover, FIG. 7 shows that, because the urgency of the recovery measures to be taken for handling the failure is “5”, the importance of the “A system” is “0.667”, the elapsed time coefficient of the failure is “0.5”, and the multiplication result of the urgency and the importance is “3.335”, the priority of the recovery work of the failure has been calculated as “6.167”.

Note that the failure information stored in the failure management table 51 is retained in the failure management table 51 for a sufficient period that is set in advance (for instance, 3 years) after the corresponding failed service server 7 recovers from the failure. Nevertheless, the period of storing the failure information in the failure management table 51 may also be decided by the customer.

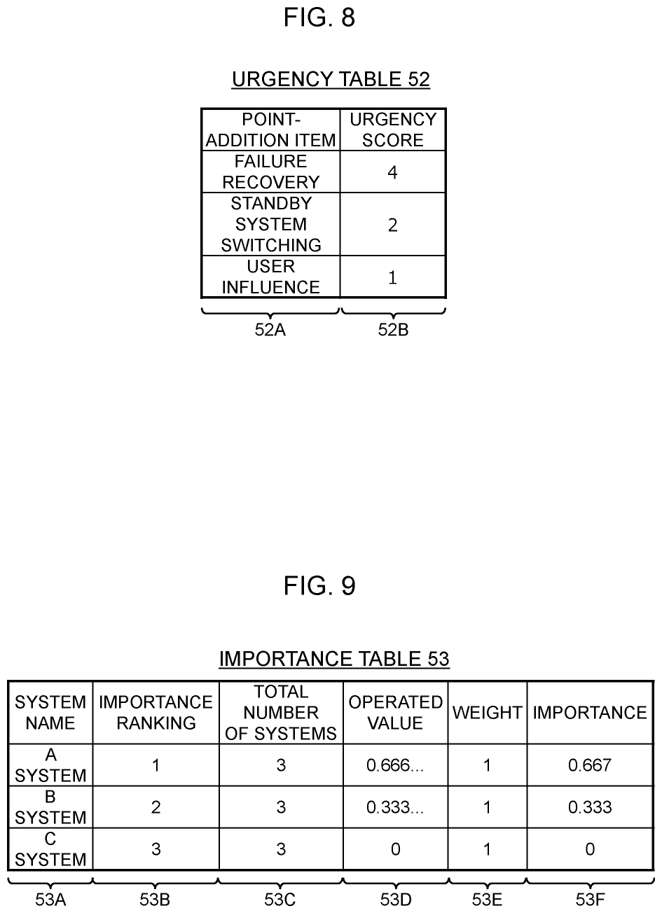

The urgency table 52 is a table that is used for managing the point-addition items to be used when the urgency calculation unit 48 calculates the urgency of the recovery measures to be taken for handling the failure that occurred in the service server 7 as a score and the point-addition score for each point-addition item (this is hereinafter referred to as the “urgency score”). The urgency table 52 is created in advance and provided to the monitoring server 10. The urgency table 52 is configured by comprising, as shown in FIG. 8, a point-addition item column 52A and an urgency score column 52B. In the urgency table 52, one entry corresponds to one point-addition item.

The point-addition item column 52A stores the pre-set point-addition items, and the urgency score column 52B stores the urgency score that is pre-set for the corresponding point-addition item. Accordingly, FIG. 8 illustrates a case where there are the three point-addition items of “failure recovery”, “standby system switching” and “user influence”, and “4”, “2” or “1” is set as the urgency score for the corresponding point-addition item.

Note that the point-addition item of “failure recovery” in FIG. 8 means that “4” points are added to the urgency when the corresponding failed service server 7 has not yet recovered from the failure, and that the urgency will consequently increase. Moreover, the point-addition item of “standby system switching” means that “2” points are added to the urgency when the processing of the corresponding failed service server 7 has not yet been switched to the service server 7 of the standby system, and the point-addition item of “user influence” means that “1” point is added to the urgency when a customer accesses the failed service server 7 while a failure is occurring in the corresponding failed service server 7.

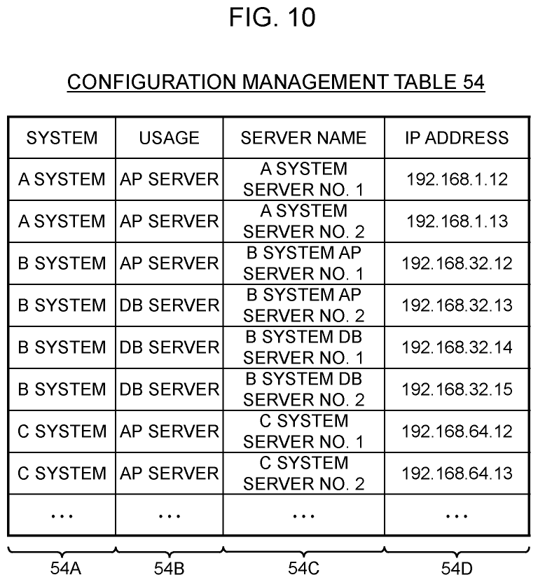

The importance table 53 is a table that is used for managing the importance of each system which was set by the customer in advance. The importance table 53 is created in advance and provided to the monitoring server 10. The importance table 53 is configured by comprising, as shown in FIG. 9, a system name column 53A, an importance ranking column 53B, a total number of systems column 53C, an operated value column 53D, a weight column 53E and an importance column 53F. In the importance table 53, one entry corresponds to one system 6 to be monitored.

The system name column 53A stores the system name of the corresponding system 6, and the total number of systems column 53C stores the total number of systems 6 to be monitored. Moreover, the importance ranking column 53B stores the ranking (importance ranking) of the corresponding system 6, which is pre-set by the user, viewed from the perspective of importance among all systems 6. The importance ranking does not need to be set, and in such a case the importance ranking is set to be the lowest ranking among all systems 6 (for instance, if the total number of systems is n, then n).

Furthermore, the operated value column 53D stores the operated value M which is calculated based on the following formula.

[Math 1]

M=1=( [symbol] / [symbol] )

M=1−(importance ranking/total number of systems) (1)

Since the operated value M is a numerical value that takes on a greater value within the range of 0 to 1 as the system 6 is more important, it could be said that the system 6 with a greater operated value M is a system of greater importance. Furthermore, the importance column 53F stores the importance of the corresponding system 6 calculated by multiplying a value, which is obtained by rounding off the operated value M to a prescribed decimal point, by the weight described later stored in the weight column 53E. To what decimal point the operated value M should be rounded off can be arbitrarily set by the user according to the number of service servers 7 to be monitored.

Furthermore, the weight column 53E stores the value of the weight that is set in advance by the user for the corresponding system 6. As described later, in the case of this embodiment, the priority against each failure is calculated by adding the urgency of the recovery measures to be taken for handling the failure, the importance of the system 6 configured from the service server 7 in which the failure has occurred, and the elapsed time coefficient calculated based on the elapsed time from the occurrence of the failure. Thus, the influence of importance of the system 6 can be increased in the calculation of the priority by increasing the value of the weight, and the influence of the system 6 can be decreased in the calculation of the priority by decreasing the value of the weight.

Accordingly, FIG. 9 illustrates a case where the importance ranking of the system 6 called the “A system” has been set to “1”, the calculated value of importance is calculated as “0.666 . . . ” since the total number of systems 6 to be monitored is “3”, and the importance of the “A system” has been defined as “0.667” since the weight is set to “1”.

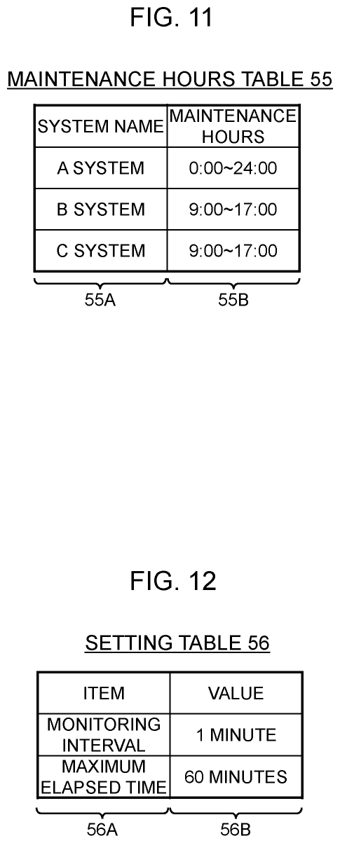

The configuration management table 54 is a table that is used for managing the configuration information of each service server 7 to be monitored, and is configured by comprising, as shown in FIG. 10, a system column 54A, a usage column 54B, a server name column 54C and an IP address column 54D. In the configuration management table 54, one entry corresponds to one service server 7 to be monitored.

The server name column 54C stores the server name of the corresponding service server 7, and the system column 54A stores the system name of the system 6 configured from the corresponding service server 7. Moreover, the usage column 54B stores the usage of the corresponding service server 7. As the types of usage of the service server, there are, for example, an application server (“AP”) and a database server (“DB”). Furthermore, the IP address column 54D stores the IP address of the corresponding service server 7.

Accordingly, FIG. 10 illustrates a case where, for example, the service server 7 having the server name of “A system server No. 1” belonging to the “A system” is a server device with the usage of “AP”, and its IP address is “192.168.1.12”.

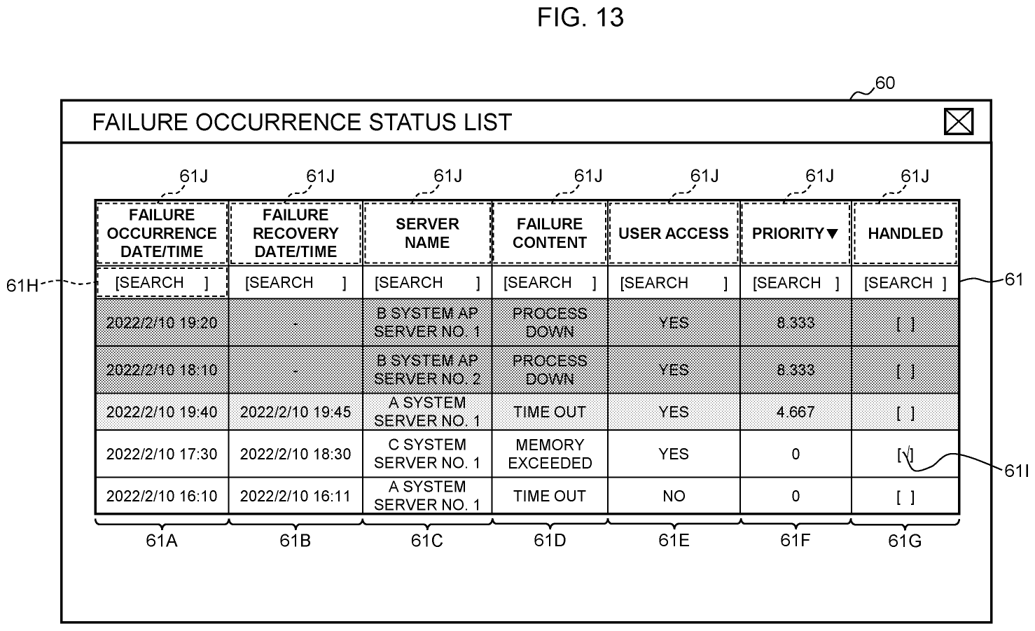

The maintenance hours table 55 is a table that is used for managing the hours that the maintenance worker 11 can perform the maintenance service to each system 6 of the data center 4 (if a failure or the like has occurred, then the hours that the maintenance worker 11 can handle the failure or the like). The maintenance hours table 55 is created in advance and provided to the monitoring server 10. The maintenance hours table 55 is configured by comprising, as shown in FIG. 11, a system name column 55A and a maintenance hours column 55B. In the maintenance hours table 55, one entry corresponds to one system 6 existing in the data center 4.

The system name column 55A stores the system name of the corresponding system 6, and the maintenance hours column 55B stores the hours that the maintenance service can be provided to the system 6. Accordingly, FIG. 11 illustrates a case where, for example, the hours that the maintenance worker 11 (FIG. 1) can perform the maintenance service are “0:00 to 24:00” regarding the “A system”, and the hours that the maintenance worker 11 can perform the maintenance service are “9:00 to 17:00” regarding the “B system”.

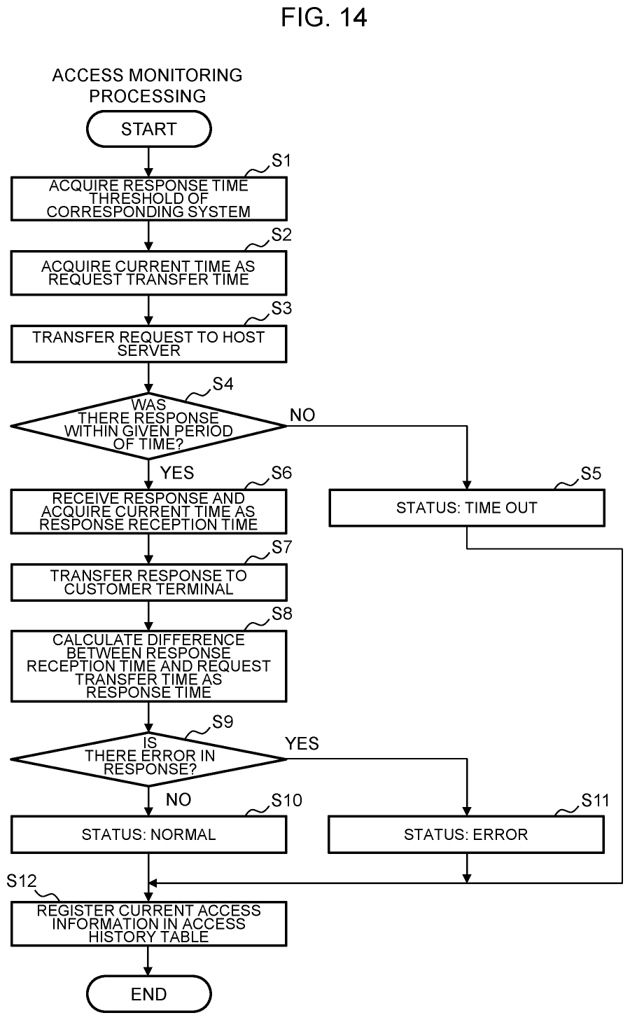

The setting table 56 is a table that is used for managing the interval that the performance monitoring manager program 46 (FIG. 2) is to collect the performance information from the performance monitoring agent program 40 (FIG. 2) of each service server 7, and the maximum elapsed time to be used upon calculating the elapsed time coefficient described later. The setting table is created in advance and provided to the monitoring server 10. The setting table 56 is configured by comprising, as shown in FIG. 12, an item column 56A and a value column 56B. In the setting table 56, one entry corresponds to one pre-set setting item.

The item column 56A stores the setting items for which a value has been set in advance (in FIG. 12, “monitoring interval” and “maximum elapsed time”), and the value column 56B stores the value set for the corresponding setting item. Accordingly, FIG. 12 illustrates a case where “1 minute” has been set as the “monitoring interval” and “60 minutes” has been set as the “maximum elapsed time”.

### (3) Configuration of Failure Occurrence Status List Screen

FIG. 13 shows a configuration example of the failure occurrence status list screen 60 that is displayed on the maintenance worker terminal 5 (FIG. 1) as a result of prescribed operations being performed using the maintenance worker terminal 5. The failure occurrence status list screen 60 is configured by comprising a failure occurrence status list 61.

The failure occurrence status list 61 is a list in which the failure information of each failure occurring in the service server 7 to be monitored in the data center 4 at that time is displayed in the order of priority of the corresponding service server 7 (failed service server 7), and is configured by comprising, as shown in FIG. 13, a failure occurrence date/time column 61A, a failure recovery date/time column 61B, a server name column 61C, a failure content column 61D, a user access column 61E, a priority column 61F and a handled column 61G.

The failure occurrence date/time column 61A, the failure recovery date/time column 61B, the server name column 61C, the failure content column 61D and the handled column 61G display the same content as the content stored in the corresponding column among the failure occurrence date/time column 51A, the failure recovery date/time column 51B, the server name column 51D, the failure content column 51 E and the handling status column 51L of the failure management table 51 described above with reference to FIG. 7.

Moreover, the user access column 61E stores information representing whether any customer terminal 3 has accessed the corresponding failed service server 7 from the occurrence of the corresponding failure up until now (“yes” if there was access, and “no” if there was no access), and the priority column 61F stores the priority of the corresponding failed service server 7.

Furthermore, in the failure occurrence status list 61, entries corresponding to the failure information of high priority among the displayed failure information are colored with a color or darkness according to the priority. For example, entries in which the priority is equal to or greater than a prescribed threshold (for instance, “7” or higher) are colored in red, and entries in which the priority falls within the prescribed range of the next level (for instance, “4” or more and less than “7”) are colored in orange. Thus, the maintenance worker 11 (FIG. 1) can immediately find the failure information of high priority among the failure information displayed in the failure occurrence status list 61 based on the color or darkness of each entry of the failure occurrence status list 61.

Moreover, the top row of the failure recovery date/time column 61B, the server name column 61C, the failure content column 61D and the handled column 61G in the failure occurrence status list 61 is provided with a text box 61H for entering a search keyword, and, by entering a character string representing the intended failure occurrence date/time, failure recovery date/time, server name, failure content, user access or no user access, priority or not handled/handled in the text box 61H and thereafter clicking the column 61J displaying the character string such as “failure occurrence date/time”, “failure recovery date/time”, “server name”, “failure content”, “user access”, “priority” or “handled” thereabove, it is possible to display on the failure occurrence status list 61 only the failure information which has been narrowed down with the entered failure occurrence date/time and other information as the search key.

Note that, when the recovery work of the failed service server 7 corresponding to the failure information displayed in the failure occurrence status list 61 is completed, the maintenance worker 11 can display a check mark 61I, which represents that the recovery work of the failed service server 7 is complete, in the handled column 61G by clicking the handled column 61G of the entry corresponding to the failed service server 7 in the failure occurrence status list 61.

Here, the fact that the foregoing operation was performed is notified to the determination result presentation unit 50 (FIG. 2) of the monitoring server 10 (FIG. 1). When the determination result presentation unit 50 receives this notice, the determination result presentation unit 50 updates the value stored in the handling status column 51L (FIG. 7) of the corresponding entry in the failure management table 51 (FIG. 7) from “not handled” to “handled”.

### (4) Various Types of Processing Executed in Relation to Failure Handling Support Function

The specific processing contents of the various types of processing to be executed by the external connection server 9 or the monitoring server 10 in relation to the failure handling support function described above are now explained. Note that, in the following explanation, while the processing agent of each type of processing is explained as a program (“. . . unit”), it goes without saying that, in effect, the processor 23 (FIG. 2) of the external connection server 9 or the processor 27 of the monitoring server 10 executes the processing based on the program.

### (4-1) Access Monitoring Processing

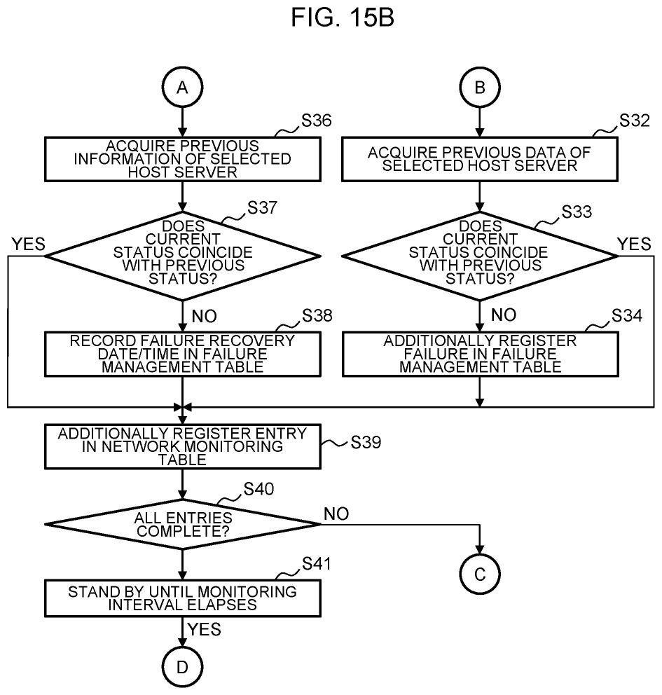

FIG. 14 shows a processing routine of the access monitoring processing to be executed by the access monitoring unit 41 (FIG. 2) of the external connection server 9. Each time that a customer terminal 3 accesses a service server 7 in the data center 4, the access monitoring unit 41 acquires information such as the response time and response content, and the response status such as “time our” or “error”, of the service server 7 in response to the access, and stores the acquired information in the access history table 43 (FIG. 3) according the processing routine shown in FIG. 14.

In effect, the access monitoring unit 41 starts the access monitoring processing shown in FIG. 14 upon receiving a request from a customer terminal 3 to any of the service servers 7 in the data center 4, and foremost refers to the response threshold table 45

(FIG. 5) and acquires the response time threshold set to the system 6 configured from the service server 7 as the transmission destination of the request (S1). Next, the access monitoring unit 41 acquires the current time as the request transfer time (S2), and thereafter transfers the request to the service server 7 of the request destination (this is hereinafter referred to as the “request destination service server 7”) (S3).

Next, the access monitoring unit 41 determines whether a response to the request from the request destination service server 7 was obtained within the period of time acquired as the response time threshold in step S1 (S4). When the access monitoring unit 41 obtains a negative result in this determination, the access monitoring unit 41 determines that the status of the current access was “time out” (S5), and thereafter proceeds to step S12.

Meanwhile, when the access monitoring unit 41 obtains a positive result in the determination of step S4, the access monitoring unit 41 receives the response, and acquires the current time as the response reception time (S6). Moreover, the access monitoring unit 41 transfers the received response to the customer terminal 3 as the transmission source of the request (S7), and additionally calculates the difference between the response reception time acquired in step S6 and the request transfer time acquired in step S2 as the response time (S8).

Furthermore, the access monitoring unit 41 determines whether the content of the response received in step S5 was an error (S9). The access monitoring unit 41 determines that the status of the current access was “normal” upon obtaining a negative result in this determination (S10), and determines that the status of the current access was an “error” upon obtaining a positive result in this determination (S11).

Next, the access monitoring unit 41 newly registers the information of the current access in the access history table 43 (FIG. 3) (S12). Specifically, the access monitoring unit 41 adds a new entry to the access history table 43, and stores the request transfer time acquired in step S2 in the date/time column 43A of that entry, stores the system name of the system 6 configured from the request destination service server 7 in the system name column 43B, stores the response reception time acquired in step S6 in the response time column 43C, stores the response content of the response acquired in step S6 in the response content column 43D, and stores the status of access determined in step S5, step S10 or step S11 in the status column 43E, respectively.

The access monitoring unit 41 thereafter ends this access monitoring processing.

### (4-2) Network Monitoring Processing

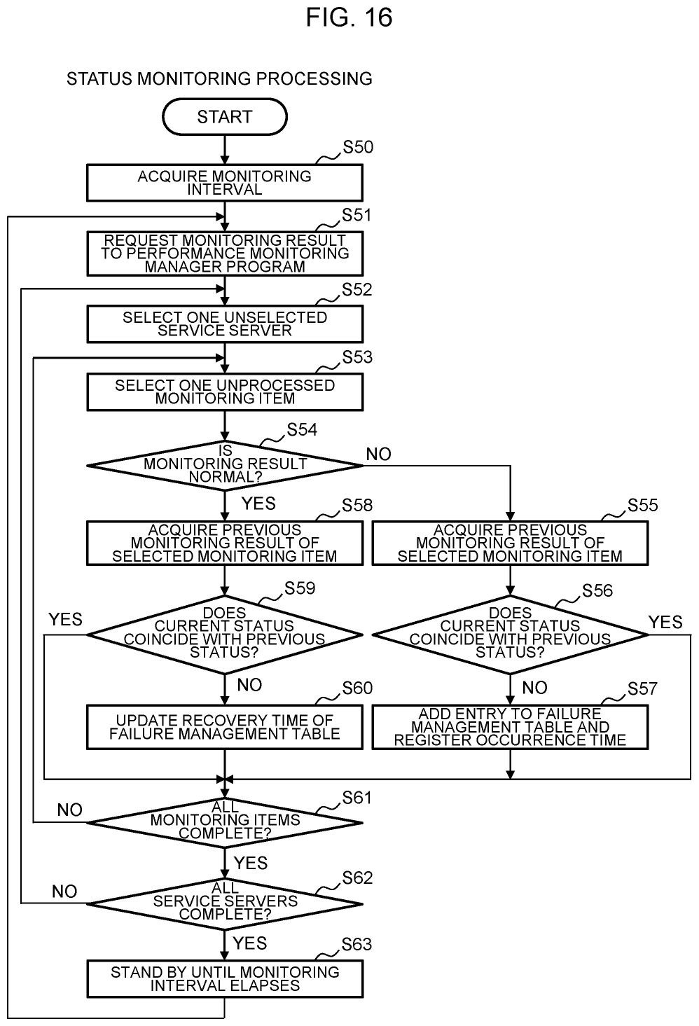

Meanwhile, FIG. 15A and FIG. 15B show the specific processing contents of the network monitoring processing to be executed by the network monitoring unit 42 (FIG. 2) of the external connection server 9. The network monitoring unit 42 monitors the status of the data center internal network 12 (FIG. 2) between each service server 7 to be monitored in the data center 4 and the external connection server 9 according to the processing routine shown in FIG. 15A and FIG. 15B.

In effect, the network monitoring unit 42 starts the network monitoring processing shown in FIG. 15A and FIG. 15B, for example, when the power of the external connection server 9 is turned on in a state where the external connection server 9 is connected to the monitoring server 10 via the data center internal network 12, and foremost accesses the monitoring server 10 and acquires the monitoring interval stored in the setting table 56 (FIG. 12) (S20).

Next, the network monitoring unit 42 accesses the monitoring server 10 and acquires the IP address of all service servers 7 to be monitored which are registered in the configuration management table 54 (FIG. 10) and the system name of the system 6 configured from these service servers 7, respectively (S21).

Next, the network monitoring unit 42 selects one service server 7 in which step S23 onward is unprocessed among the respective service servers 7 in which their address and system name were acquired in step S21 (S22). Moreover, based on the system name of the service server selected in step S22 (this is hereinafter referred to as the “selected service server” in the explanation of FIG. 15A and FIG. 15B), the network monitoring unit 42 acquires, from the response threshold table 45 (FIG. 5), the response time threshold of the system 6 configured from the elected service server 7 (S23).

Furthermore, the network monitoring unit 42 acquires the current time (S24), and thereafter sends a response time measurement request to the selected service server 7 (S25). Moreover, the network monitoring unit 42 thereafter determines whether a response from the selected service server 7 in response to the response time measurement request was received within the period of time acquired as the response time threshold in step S23 (S26).

When the network monitoring unit 42 obtains a negative result in this determination, the network monitoring unit 42 determines that the status of the data center internal network 12 between the external connection server 9 and the selected service server 7 is “time out” (S27), and thereafter proceeds to step S32.

Meanwhile, when the network monitoring unit 42 obtains a positive result in the determination of step S26, the network monitoring unit 42 receives the response (S28), and calculates the response time from the transmission of the response time measurement request to the reception of a response to the response time measurement request based on the time acquired in step S24 and the current time (S29). Specifically, the network monitoring unit 42 calculates the response time by subtracting the time acquired in step S24 from the current time.

Next, the network monitoring unit 42 determines whether the response received in step S28 contains an error (S30). When the network monitoring unit 42 obtains a positive result in this determination, the network monitoring unit 42 determines that the status of the data center internal network 12 between the external connection server 9 and the selected service server 7 is an “error” (S31).

Moreover, the network monitoring unit 42 acquires, from the network monitoring table 44 (FIG. 4), information related to the status of the data center internal network 12 between the external connection server 9 and the selected service server 7 obtained in the previous cycle (processing of step S21 to step S41 in the previous cycle) (S32), and determines whether the status of the data center internal network 12 between the external connection server 9 and the selected service server 7 obtained in the current cycle (processing of step S21 to step S41 in the current cycle) and the status of the data center internal network 12 between the external connection server 9 and the selected service server 7 in the previous cycle coincide (S33).

To obtain a negative result in this determination means that, since the current status of the data center internal network 12 between the external connection server 9 and the selected service server 7 is “time out” or “error” and the previous status of the data center internal network is “normal” or “error” when the current status is “time out” and is “normal” or “time out” when the current status is “error”, a new failure may have occurred in the data center internal network 12 between the external connection server 9 and the selected service server 7 during the period from the previous cycle to the current cycle.

Consequently, the network monitoring unit 42 accesses the monitoring server 10 and additionally registers the failure that occurred in the data center internal network 12 between the external connection server 9 and the selected service server 7 in the failure management table 51 (S34). Specifically, the network monitoring unit 42 adds an entry to the failure management table 51, and stores the current date/time in the failure occurrence date/time column 51A of that entry, stores the system name of the system 6 configured from the selected service server 7 in the system name column 51C, stores the server name of the selected service server 7 in the server name column 51D, and stores the failure content of the current failure in the data center internal network 12 between the external connection server 9 and the selected service server 7 in the failure content column 51E, respectively. The network monitoring unit 42 thereafter proceeds to step S39.

Meanwhile, to obtain a positive result in the determination of step S33 means that the current status of the data center internal network 12 between the external connection server 9 and the selected service server 7 is “time out” or “error” and the previous status of the data center internal network is also “time out” or “error”, and that the corresponding failure is already registered in the failure management table 51. Consequently, the network monitoring unit 42 proceeds to step S39 without performing any kind of processing.

Meanwhile, when the network monitoring unit 42 obtains a negative result in the determination of step S30, the network monitoring unit 42 determines that the status of the data center internal network 12 between the external connection server 9 and the selected service server 7 is “normal” (S35).

Moreover, the network monitoring unit 42 acquires, from the network monitoring table 44 (FIG. 4), information related to the status of the data center internal network 12 between the external connection server 9 and the selected service server 7 obtained in the previous cycle (S36), and determines whether the status of the data center internal network 12 between the external connection server 9 and the selected service server 7 obtained in the current cycle and the status of the data center internal network 12 between the external connection server 9 and the selected service server 7 in the previous cycle coincide (S37).

To obtain a negative result in this determination means that, since the current status of the data center internal network 12 between the external connection server 9 and the selected service server 7 is “normal” and the previous status of the data center internal network 12 is other than “normal”, the status of the data center internal network 12 between the external connection server 9 and the selected service server 7 has recovered from a failure status during the period from the previous cycle to the current cycle.

Consequently, the network monitoring unit 42 accesses the monitoring server 10 and identifies the entry corresponding to the failure registered in the failure management table 51 (FIG. 7) (failure that had previously occurred in the data center internal network 12 between the external connection server 9 and the selected service server 7), and stores the current date/time as the failure recovery date/time in the failure recovery date/time column 51B (FIG. 7) of that entry (S38). The network monitoring unit 42 thereafter proceeds to step S39.

Meanwhile, to obtain a positive result in the determination of step S37 means that the current status of the data center internal network 12 between the external connection server 9 and the selected service server 7 is “normal” and the previous status of the data center internal network 12 is also “normal”. Consequently, the network monitoring unit 42 proceeds to step S39 without performing any kind of processing.

When the network monitoring unit 42 proceeds to step S39, the network monitoring unit 42 registers the current monitoring result in the network monitoring table 44 (S39). Specifically, the network monitoring unit 42 adds a new entry to the network monitoring table 44, and stores the current date/time in the date/time column 44A of that entry, stores the server name of the selected service server 7 in the server name column 44B, stores the response time calculated in step S29 (“−” when the current status is “time out”) in the response time column 44C, and stores the status of the data center internal network 12 between the external connection server 9 and the selected service server 7 determined in step S27, step S31 or step S35 in the status column 44D, respectively.

Next, the network monitoring unit 42 determines whether the processing of step S23 to step S39 has been performed for all service servers 7 in which their address and system name were acquired in step S21 (S40). The network monitoring unit 42 returns to step S22 upon obtaining a negative result in this determination, and thereafter repeats the processing of step S22 to step S41 while sequentially switching the service server 7 selected in step S22 to another service server 7 in which step S23 onward is unprocessed.

When the network monitoring unit 42 eventually obtains a positive result in step S40 as a result of the processing of step S23 to step S39 being performed for all service servers 7 to be monitored, the network monitoring unit 42 stands by until the lapse of the period of time of the monitoring internal acquired in step S20 from the time that the current cycle was started (S41).

The network monitoring unit 42 returns to step S21 when the period of time of the monitoring internal acquired in step S20 eventually elapses from the time that the current cycle was started, and thereafter repeats the processing of step S21 onward in the same manner as described above.

### (4-3) Status Monitoring Processing

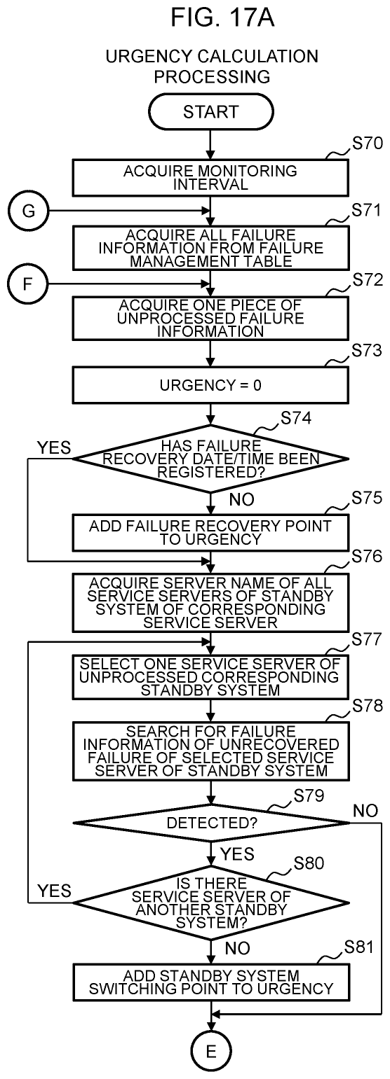

FIG. 16 shows the flow of the status monitoring processing to be executed by the status monitoring unit 47 (FIG. 2) of the monitoring server 10. The status monitoring unit 47 monitors the status of each service server 7 to be monitored in the data center 4 according to the processing routine shown in FIG. 16.

In effect, the status monitoring unit 47 starts the status monitoring processing shown in FIG. 16 when the power of the monitoring server 10 is turned on, and foremost acquires, by reading, the monitoring interval stored in the setting table 56 (FIG. 12) (S50).

Moreover, the status monitoring unit 47 requests the performance monitoring manager program 46 to transfer the various types of information described above with reference to FIG. 6, which were collected by the performance monitoring manager program 46 (FIG. 2) from the performance monitoring agent program 40 (FIG. 2) of each service server 7, and thereby acquires the foregoing information (S51).

Next, the status monitoring unit 47 selects one service server 7 in which step S53 onward is unprocessed among the respective service servers 7 in which their information was acquired in step S51 (S52), and selects one monitoring item in which step S54 onward is unprocessed among the respective monitoring items (see FIG. 6) of alive monitoring, process monitoring, log and resource monitoring acquired regarding the selected service server 7 (this is hereinafter referred to as the “selected service server 7” in the explanation of FIG. 16) (S53).

Next, the status monitoring unit 47 extracts the monitoring result of the monitoring item selected in step S53 (this is hereinafter referred to as the “selected monitoring item”) related to the selected service server 7 among the information acquired in step S51, and determines whether the monitoring result of that monitoring item is “normal” (S54).

When the status monitoring unit 47 obtains a negative result in this determination, the status monitoring unit 47 extracts the monitoring result of the selected monitoring item of the selected service server 7 acquired in the previous cycle (processing of step S51 to step S63 in the previous cycle) among the information acquired in step S51 (S55), and determines whether the monitoring result of the selected monitoring item of the selected service server 7 in the current cycle (processing of step S51 to step S63 in the current cycle) and the monitoring result in the previous cycle coincide (S56).

To obtain a negative result in this determination means that, since the monitoring result of the selected monitoring item of the selected service server 7 in the previous cycle is “normal” and the current monitoring result is other than “normal”, some kind of failure that will influence the selected monitoring item has occurred in the selected service server 7 during the period from the previous cycle to the current cycle.

Consequently, the status monitoring unit 47 additionally registers the current monitoring result in the failure management table 51 (FIG. 7) (S57). Specifically, the status monitoring unit 47 adds a new entry to the failure management table 51, and stores the current date/time in the failure occurrence date/time column 51A, stores the system name of the system 6 configured from the selected service server 7 in the system name column 51C, stores the server name of the selected service server 7 in the server name column 51D, and stores the current monitoring result of the selected monitoring item in the failure content column 51E, respectively. The status monitoring unit 47 thereafter proceeds to step S61.

Meanwhile, to obtain a positive result in the determination of step S56 means that the monitoring results of the selected monitoring item of the selected service server 7 in the previous cycle and the current cycle are both a monitoring result other than “normal”, and that the failure that caused these monitoring results has already been registered in the failure management table 51 in step S57 of the previous cycle. Consequently, the status monitoring unit 47 proceeds to step S61 without performing any kind of processing.

Meanwhile, when the status monitoring unit 47 obtains a positive result in the determination of step S54, the status monitoring unit 47 extracts the monitoring result of the selected monitoring item of the selected service server 7 acquired in the previous cycle among the information acquired in step S51 (S58), and determines whether the monitoring result of the selected monitoring item of the selected service server 7 in the current cycle and the monitoring result in the previous cycle coincide (S59).

To obtain a negative result in this determination means that the monitoring result of the selected monitoring item of the selected service server 7 in the previous cycle is a monitoring result other than “normal” and that the current monitoring result is “normal”, and that recovery work was performed regarding the selected monitoring item of the selected service server 7 during the period from the previous cycle to the current cycle.

Consequently, the status monitoring unit 47 registers the current date/time as the failure recovery date/time in the failure recovery date/time column 51B of the entry corresponding to the selected monitoring item of the selected service server 7 registered in the failure management table 51 in the previous cycle (S60).

Meanwhile, to obtain a positive result in the determination of step S59 means that the monitoring results of the selected monitoring item of the selected service server 7 in the previous cycle and the current cycle are both “normal”. Consequently, the status monitoring unit 47 proceeds to step S61 without performing any kind of processing.

Moreover, when the status monitoring unit 47 proceeds to step S61, the status monitoring unit 47 determines whether the processing of step S54 to step S60 has been performed for all monitoring items in relation to the selected service server 7 (S61). The status monitoring unit 47 returns to step S53 upon obtaining a negative result in this determination, and thereafter repeats the processing of step S53 to step S61 while sequentially switching the monitoring item selected in step S53 to another monitoring item in which step S54 onward is unprocessed.

When the status monitoring unit 47 eventually obtains a positive result in step S61 as a result of the processing of step S54 to step S60 being performed for all monitoring items of the selected service server 7, the status monitoring unit 47 determines whether the processing of step S53 to step S60 has been performed for all service servers 7 to be monitored (S62).

The status monitoring unit 47 returns to step S52 upon obtaining a negative result in this determination, and thereafter repeats the processing of step S52 to step S62 while switching the service server 7 selected in step S52 to another service server 7 in which step S53 onward is unprocessed.

When the status monitoring unit 47 eventually obtains a positive result in step S62 as a result of the processing of step S53 to step S61 being performed for all service servers 7 to be monitored, the status monitoring unit 47 stands by until the elapsed time from the time that the processing of step S51 onward was started in the current cycle reaches the period of time of the monitoring interval acquired in step S50 (S63). The status monitoring unit 47 returns to step S51 as a result of the elapsed time from the time that the processing of step S51 onward was started in the current cycle reaching the period of time of the monitoring interval acquired in step S50, and thereafter repeats the processing of step S51 onward in the same manner as described above.

### (4-4) Urgency Calculation Processing

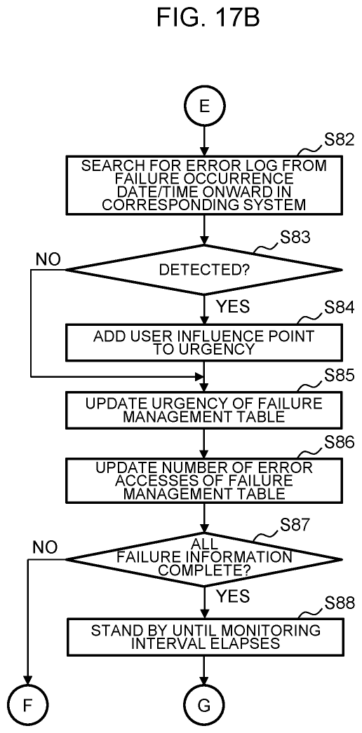

FIG. 17A and FIG. 17B show the flow of the urgency calculation processing to be executed by the urgency calculation unit 48 (FIG. 2) of the monitoring server 10. The urgency calculation unit 48 calculates the urgency of handling each failure with regard to each piece of failure information registered in the failure management table 51 (FIG. 7) according to the processing routine shown in FIG. 17A and FIG. 17B.

In effect, the urgency calculation unit 48 starts the urgency calculation processing shown in FIG. 17A and FIG. 17B when the power of the monitoring server 10 is turned on, and foremost reads the monitoring interval stored in the setting table 56 (FIG. 12) (S70). Moreover, the urgency calculation unit 48 reads all failure information (information of each entry) registered in the failure management table 51 (S71), and selects one piece of failure information in which step S73 onward is unprocessed among the failure information that was read (S72).

Next, the urgency calculation unit 48 sets the urgency of the failure information selected in step S72 (this is hereinafter referred to as the “selected failure information” in the explanation of FIG. 17A and FIG. 17B) to “0” (S73), and thereafter determines whether the failure recovery date/time of the selected failure information is registered in the failure management table 51 (S74). This determination is made based on whether the date/time is stored in the failure recovery date/time column 51B (FIG. 7) of the entry corresponding to the selected failure information in the failure management table 51.

The urgency calculation unit 48 proceeds to step S76 upon obtaining a positive result in this determination. Meanwhile, when the urgency calculation unit 48 obtains a negative result in the determination of step S74, the urgency calculation unit 48 reads the urgency score (“4” in FIG. 8) of the point-addition item called “failure recovery” from the urgency table 52 (FIG. 8), and adds the read urgency score to the urgency score of the selected failure information (S75).

Next, the urgency calculation unit 48 acquires, from the configuration management table 54 (FIG. 10), the server name of all service servers 7 of the standby system in relation to the service server 7 corresponding to the selected failure information (the service server 7 in which the corresponding failure has occurred; hereinafter referred to as the “corresponding service server 7” in the explanation of FIG. 17A and FIG. 17B) (S76). Specifically, the urgency calculation unit 48 extracts, among the respective entries of the configuration management table 54, all entries in which the system name of the system 6 configured from the corresponding service server 7 is stored in the system column 54A and the usage of that system 6 is stored in the usage column 54B. Subsequently, the urgency calculation unit 48 acquires, among the server names respectively stored in the server name column 54C of the extracted entries, server names other than the server name of the corresponding service server 7 as the server name of the service server 7 of the standby system of the corresponding service server 7.

Next, the urgency calculation unit 48 selects, among the service servers 7 of the server name acquired in step S76 (each a service server 7 of the standby system in relation to the corresponding service server 7; hereinafter referred to as the “corresponding standby system service server 7”), one corresponding standby system service server 7 in which step S78 onward is unprocessed (S77).

Moreover, the urgency calculation unit 48 searches for the failure information of a not-yet-recovered failure related to the corresponding standby system service server 7 selected in step S77 among all failure information read from the failure management table in step S71 (S78). Specifically, the urgency calculation unit 48 searches for the failure information in which the server name is the server name of the corresponding standby system service server 7 selected in step S77, the failure occurrence date/time on and after the occurrence of the failure in the corresponding service server 7 has been registered, and the failure recovery date/time has not been registered. Moreover, the urgency calculation unit 48 thereafter determines whether it was possible to detect the foregoing failure information (S79).

Here, to obtain a negative result in the determination of step S79 means that a not-yet-recovered failure is not occurring in the corresponding standby system service server 7 selected in step S77, and that the corresponding standby system service server 7 is operating normally. Thus, it could be said that there is no need for that much haste in recovering the corresponding service server 7. Consequently, the urgency calculation unit 48 proceeds to step S82.

Meanwhile, to obtain a positive result in the determination of step S79 means that a failure is currently occurring in the corresponding standby system service server 7 selected in step S77, and that the corresponding standby system service server 7 is not operating normally. Consequently, the urgency calculation unit 48 determines whether a service server 7 of another standby system of the corresponding service server 7 had been detected in step S76 (S80).

The urgency calculation unit 48 returns to step S77 upon obtaining a positive result in this determination, and thereafter repeats the processing of step S77 to step S80 until a negative result is obtained in step S79 or step S80 while sequentially switching the service server 7 of the standby system selected in step S77 to another service server 7 in which its server name was acquired in step S75 and in which step S78 onward is unprocessed. As a result of this kind of repetitive processing, it is possible to determine, in order, whether a not-yet-recovered failure is currently occurring regarding all service servers 7 in which their server name was acquired in step S76 (each a service server 7 of the standby system of the corresponding service server 7).

Subsequently, when it is determined that a not-yet-recovered failure is occurring in all service servers 7 in which their server name was acquired in step S76 based on this repetitive processing (when a negative result is obtained in step S80), since this means that a not-yet-recovered failure is occurring in the service servers 7 of all standby systems of the corresponding service server 7, it means that the corresponding service server 7 needs to be recovered urgently. Consequently, the urgency calculation unit 48 reads the urgency score (“2” in FIG. 8) of the point-addition item called “standby system switching” from the urgency table 52, and adds the read urgency score to the current urgency score of the selected failure information (S81).

Next, the urgency calculation unit 48 accesses the external connection server 9, and searches the access history table 43 (FIG. 3) for an error log generated on and after the date/time (failure occurrence date/time) that a failure occurred in the corresponding service server 7 in the system 6 configured from the corresponding service server 7 (S82). Specifically, the urgency calculation unit 48 searches the access history table 43 for an entry in which the date/time that is on and after the failure occurrence date/time is stored in the date/time column 43A, the system name of the system 6 configured from the corresponding service server 7 is stored in the system name column 43B, and a status (“error” or “time out”) other than “normal” is stored in the status column 43E.

Subsequently, the urgency calculation unit 48 determines whether it was possible to detect an entry of the error log described above based on this search (S83).

To obtain a negative result in this determination means that no customer terminal 3 has accessed the corresponding service server 7 during the period from the occurrence of a failure in the corresponding service server 7 up until now, and the failure of the corresponding service server 7 is not influencing the customers using the corresponding service server 7. Thus, it could be said that the necessity of rushing the recovery of the corresponding service server 7 is low. Consequently, the urgency calculation unit 48 proceeds to step S85.

Meanwhile, to obtain a positive result in the determination of step S83 means that there was a customer terminal 3 that accessed the corresponding service server 7 during the period from the occurrence of a failure in the corresponding service server 7 up until now, and the failure of the corresponding service server 7 is influencing the customers using the corresponding service server 7. Thus, it could be said that the necessity of rushing the recovery of the corresponding service server 7 is high.

Consequently, the urgency calculation unit 48 reads the urgency score (“1” in FIG. 8) of the point-addition item called “user influence” from the urgency table 52 (FIG. 8), and adds the read urgency score to the current urgency score of the selected failure information (S84).

Next, the urgency calculation unit 48 updates the value stored in the urgency column 51G of the entry corresponding to the current failure of the corresponding service server 7 in the failure management table 51 (FIG. 7) to the value of urgency of the corresponding service server 7 calculated heretofore (S85), and updates the value stored in the number of error accesses column 51F of that entry to the number of error logs detected in step S82 (S86).

The urgency calculation unit 48 thereafter determines whether the processing of step S73 to step S86 has been performed for all failure information read from the failure management table 51 in step S71 (S87). The urgency calculation unit 48 returns to step S72 upon obtaining a negative result in this determination, and thereafter repeats the processing of step S72 to step S87 while sequentially switching the failure information selected in step S72 to another piece of failure information in which step S73 onward is unprocessed.

When the urgency calculation unit 48 eventually obtains a positive result in step S87 as a result of the processing of step S73 to step S86 being performed for all failure information read from the failure management table 51 in step S71, the urgency calculation unit 48 thereafter stands by until the lapse of the period of time of the monitoring internal acquired in step S70 from the time that the processing of the current cycle (processing of step S71 to step S88) was started (S88).

The urgency calculation unit 48 returns to step S71 when the period of time of the monitoring internal acquired in step S70 eventually elapses from the time that the processing of the current cycle was started, and thereafter repeats the processing of step S71 onward.

### (4-5) Priority Determination Processing

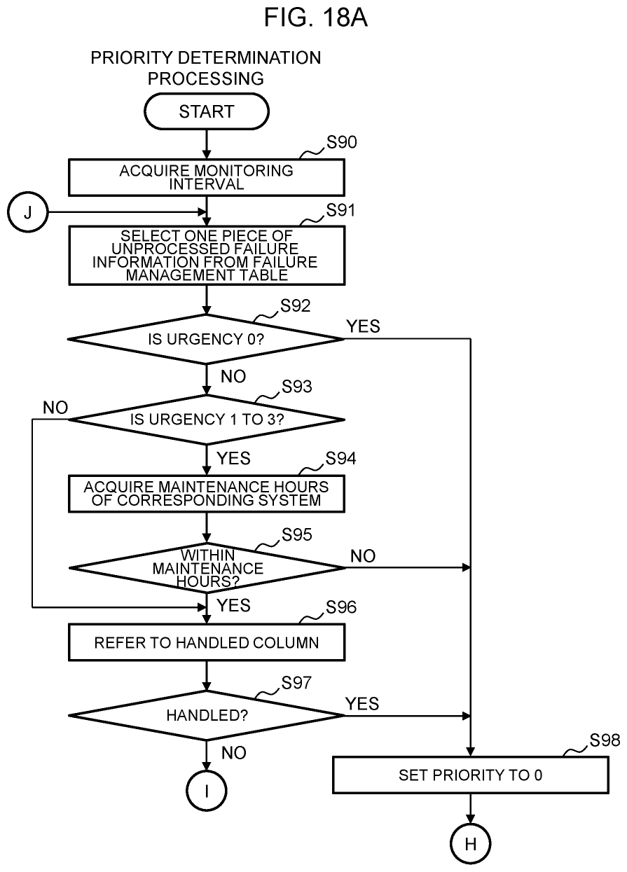

FIG. 18A and FIG. 18B show the flow of the priority determination processing to be executed by the priority determination unit 49 (FIG. 2) of the monitoring server 10. The priority determination unit 49 determines the corresponding priority of each failure with regard to each piece of failure information registered in the failure management table 51 (FIG. 7) according to the processing routine shown in FIG. 18A and FIG. 18B.

In effect, the priority determination unit 49 starts the priority determination processing shown in FIG. 18A and FIG. 18B when the power of the monitoring server 10 is turned on, and foremost reads the monitoring interval stored in the setting table 56 (S90). Moreover, the priority determination unit 49 selects one piece of failure information in which step S92 onward is unprocessed among all failure information registered in the failure management table 51, and reads the selected failure information (this is hereinafter referred to as the “selected failure information” in the explanation of FIG. 18A and FIG. 18B) from the failure management table 51 (S91).

Next, the priority determination unit 49 determines whether the urgency of the selected failure information is set to “0” (S92). When the priority determination unit 49 obtains a positive result in this determination, the priority determination unit 49 sets the priority of the selected failure information to “0” (S98). Specifically, the priority determination unit 49 stores “0” in the priority column 51K of the entry corresponding to the selected failure information in the failure management table 51. The priority determination unit 49 thereafter ends this priority determination processing.

Moreover, when the priority determination unit 49 obtains a negative result in the determination of step S92, the priority determination unit 49 determines whether the urgency of the selected failure information is set to any value of “1” to “3” (S93). The priority determination unit 49 proceeds to step S96 upon obtaining a negative result in this determination.

Meanwhile, when the priority determination unit 49 obtains a positive result in the determination of step S93, the priority determination unit 49 reads the maintenance hours of the system 6 corresponding to the selected failure information from the maintenance hours table 55 (FIG. 11) (S94). Specifically, the priority determination unit 49 reads the system name stored in the system name column 51C of the entry corresponding to the selected failure information in the failure management table 51, and reads the maintenance hours stored in the maintenance hours column 55B of the entry in which the read system name is stored in the system name column 55A of the maintenance hours table 55.

Next, the priority determination unit 49 determines whether the current time is within the maintenance hours read from the maintenance hours table 55 in step S94 (whether the current time is within the maintenance hours of the system 6 corresponding to the selected failure information) (S95). When the priority determination unit 49 obtains a negative result in this determination, the priority determination unit 49 sets the priority of the selected failure information to “0” (S98), and thereafter ends this priority determination processing.

Meanwhile, when the priority determination unit 49 obtains a positive result in the determination of step S95, the priority determination unit 49 refers to the handling status column 51L of the entry corresponding to the selected failure information in the failure management table 51 (S96), and determines whether the maintenance worker 11 (FIG. 1) has already handled the failure corresponding to the selected failure information (whether the corresponding service server 7 has recovered from the failure) (S97). When the priority determination unit 49 obtains a positive result in this determination, the priority determination unit 49 sets the priority of the selected failure information to “0” (S98), and thereafter ends this priority determination processing.

Meanwhile, when the priority determination unit 49 obtains a negative result in the determination of step S97, the priority determination unit 49 acquires, from the importance table 53 (FIG. 9), the importance of the system 6 (this is hereinafter referred to as the “corresponding system 6”) configured from the service server 7 corresponding to the selected failure information (service server 7 in which the corresponding failure has occurred) (S99). Specifically, the priority determination unit 49 reads the system name of the corresponding system 6 from the system name column 51C of the entry corresponding to the selected failure information in the failure management table 51, and reads the importance stored in the importance column 53F of the entry in which the system name in the importance table 53 is stored in the system name column 53A.

Next, the priority determination unit 49 calculates the temporary priority of the failure corresponding to the selected failure information (this is hereinafter referred to as the “temporary priority”) by adding the urgency of the corresponding failure stored in the urgency column 51G of the entry corresponding to the selected failure information in the failure management table 51, and the importance of the corresponding system (S100).

Moreover, the priority determination unit 49 calculates the elapsed time from the occurrence of the failure corresponding to the selected failure information (S101). Specifically, the priority determination unit 49 reads the failure occurrence date/time of the failure corresponding to the selected failure information from the failure occurrence date/time column 51A of the entry corresponding to the selected failure information in the failure management table 51, and calculates the difference between the read failure occurrence date/time and the current time as the elapsed time.

Next, the priority determination unit 49 reads the maximum elapsed time from the setting table 56 (FIG. 12) (S102), and calculates the elapsed time coefficient of the failure corresponding to the selected failure information based on the read maximum elapsed time, and the elapsed time calculated in step S100 (S103).

The elapsed time coefficient is a coefficient that changes according to the elapsed time from the occurrence of the failure corresponding to the selected failure information, and is calculated according to a certain rule where its numerical value will increase as the elapsed time increases.

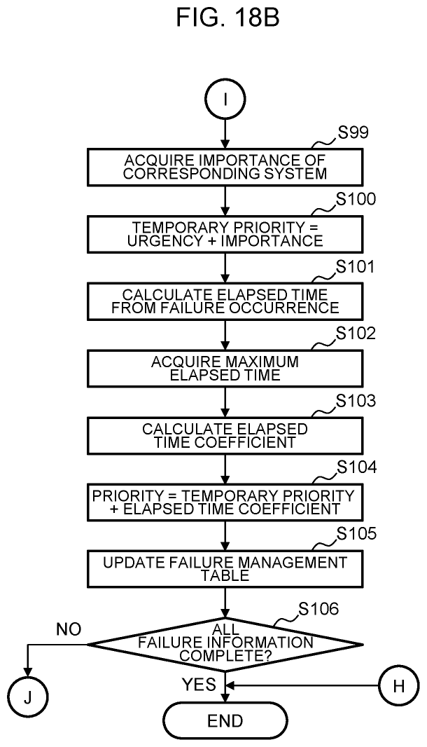

This kind of rule may be set arbitrarily. For example, as shown in FIG. 19, when the maximum elapsed time read from the setting table 56 in step S102 is “60 minutes”, the elapsed time coefficient when the elapsed time is “0 minutes” may be set to “0”, the elapsed time coefficient when the elapsed time is “30 minutes” may be set to “0.5”, and the elapsed time coefficient when the elapsed time is “60 minutes” may be set to “1”, and applied may be a rule where the value of the elapsed time coefficient changes linearly when the elapsed time is between “0 minutes” and “30 minutes” or when the elapsed time is between “30 minutes” and “60 minutes”, and the elapsed time coefficient is set to “1” when the elapsed time is “60 minutes or longer”. Moreover, the elapsed time coefficient may be set to be “1” or higher.

Next, the priority determination unit 49 calculates the priority of the failure corresponding to the selected failure information by adding the elapsed time coefficient calculated in step S103 to the temporary priority calculated in step S100 (S104).

Moreover, the priority determination unit 49 updates the failure management table 51 based on the calculation result of step S104 (S105). Specifically, the priority determination unit 49 stores the importance acquired in step S99 in the importance column 51H of the entry corresponding to the selected failure information in the failure management table 51, stores the elapsed time coefficient calculated in step S103 in the elapsed time coefficient column 51I of that entry, stores the product of the urgency and the importance of the failure corresponding to the selected failure information in the urgency×importance column 51J of that entry, and stores the priority calculated in step S104 in the priority column 51K of that entry.

Furthermore, the priority determination unit 49 determines whether the processing of step S92 to step S105 has been performed for all failure information registered in the failure management table 51 (S106). The priority determination unit 49 returns to step S91 upon obtaining a negative result in this determination, and thereafter repeats the processing of step S91 to step S106 while sequentially switching the failure information (entry) selected in step S91 to another piece of failure information in which step S92 onward is unprocessed. As a result of this kind of repetitive processing, the priority and other items regarding all failure information registered in the failure management table 51 are calculated, and their values are registered in the failure management table 51. When the priority determination unit 49 eventually obtains a positive result in step S106 as a result of completing the registration in the failure management table 51 of the priority and other items regarding all failure information registered in the failure management table 51, the priority determination unit 49 ends this priority determination processing.

### (4-6) Determination Result Presentation Processing

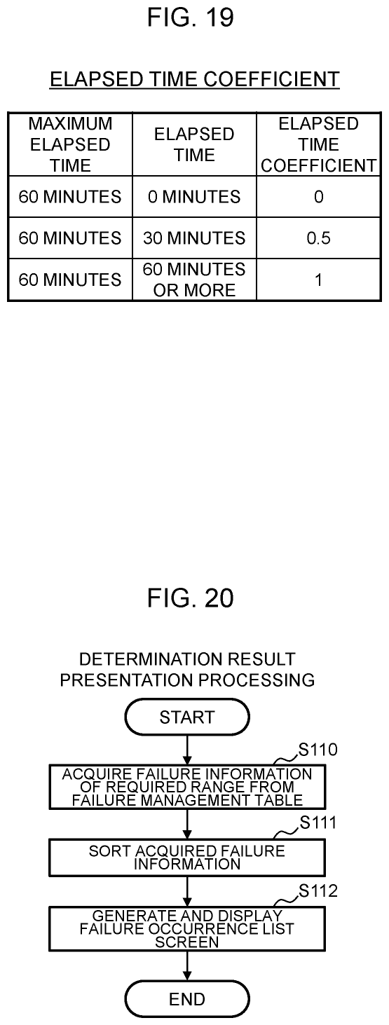

FIG. 20 shows the flow of the determination result presentation processing to be executed by the determination result presentation unit 50 (FIG. 2) of the monitoring server 10. With the information processing system 1, as a result of the maintenance worker 11 (FIG. 1) performing prescribed operations with the maintenance worker terminal 5 (FIG. 1), a display request of the failure occurrence status list screen 60 (FIG. 13) is sent from the maintenance worker terminal 5 to the monitoring server 10 (this is hereinafter referred to as the “failure occurrence status list screen display request”). When the failure occurrence status list screen display request is sent, the determination result presentation unit 50 displays the failure occurrence status list screen 60 on the maintenance worker terminal 5 according to the processing routine shown in FIG. 20.

In effect, the determination result presentation unit 50 starts the determination result presentation processing upon receiving the failure occurrence status list screen display request, and foremost acquires the failure information of the required range from the failure management table 51 (FIG. 7) (S110). Here, for example, if a temporal range (for instance, most recent one-week period) to be displayed on the failure occurrence status list screen 60 has been pre-determined, “required range” corresponds to such range. Moreover, when the maintenance worker 11 designates a period of the failure occurrence date/time, such period will be the “required range”.

Next, the determination result presentation unit 50 sorts each piece of failure information acquired in step S110 in order from the highest priority (S111). Here, when there are multiple pieces of failure information having the same priority, the determination result presentation unit 50 sorts such failure information in order from the failure occurrence date/time that is later. Moreover, when there are multiple pieces of failure information having the same priority and the same failure occurrence date/time, the determination result presentation unit 50 sorts such failure information in order from the smallest value of the product of urgency and importance (urgency x importance). Furthermore, when there are multiple pieces of failure information having the same priority, the same failure occurrence date/time, and the same value of the product of urgency and importance, the determination result presentation unit 50 sorts such failure information in order from the greatest number of error accesses.

Next, the determination result presentation unit 50 generates the failure occurrence status list 61 described above with reference to FIG. 13 which lists each piece of failure information acquired from the failure management table in step S110 and sorted in step S111, and sends the screen data of the failure occurrence status list screen 60 including the failure occurrence status list 61 to the maintenance worker terminal 5 as the transmission source of the failure occurrence status list display request described above. The failure occurrence status list screen 60 is thereby displayed on the maintenance worker terminal 5 (S112). The determination result presentation unit 50 thereafter ends this determination result presentation processing.

### (4-7) Handled Check Processing

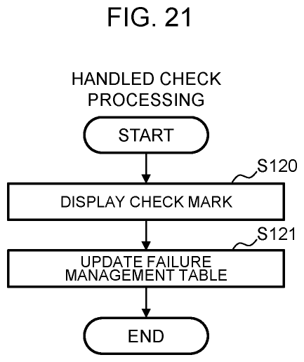

Meanwhile, FIG. 21 shows the flow of the handled check processing to be executed by the determination result presentation unit 50 when the handled column 61G of any entry not displaying the check mark 61I in the failure occurrence status list 61 of the failure occurrence status list screen 60 (that is, an entry of failure information in which the corresponding failure has not yet been handled) is clicked. When the handled column 61G is clicked, the determination result presentation unit 50 updates the failure management table 51 (FIG. 7) according to the processing routine shown in FIG. 21.

In effect, the determination result presentation unit 50 starts the handled check processing shown in FIG. 21 when the handled column 61G of any entry with no indication of the check mark 61I in the failure occurrence status list 61 of the failure occurrence status list screen 60 is clicked, and foremost displays the check mark 61I in that handled column 61G of that entry in the failure occurrence status list 61 (this is hereinafter referred to as the “corresponding entry” in the explanation of FIG. 21) (S120).

Next, the determination result presentation unit 50 updates the value stored in the handling status column 51L (FIG. 7) of the entry of the failure management table 51 corresponding to the corresponding entry of the failure occurrence status list 61 from “not handled” to “handled” (S121), and thereafter ends this handled check processing.

### (5) Effect of this Embodiment

As described above, with the information processing system 1 of this embodiment, the external connection server 9 and the monitoring server 10 configuring the failure handling support system 8 are used to monitor the status of the service servers 7 to be monitored in the data center 4 and the status of the data center internal network 12, and, if a failure in the service servers 7 or the data center internal network 12 is detected, the priority of the recovery measures to be taken for handling the detected failure is calculated for each failure, and the failure information of each failure is sorted in order according to the calculated priority and presented to the maintenance worker 11.

Here, the monitoring server 10 calculates the urgency of the recovery measures to be taken for handling each failure based on whether there has been any access from the customer terminal 3 from the occurrence of the failure up until now in addition to whether a recovery from the failure has been achieved and whether switching to a standby system has been performed, and the priority of the recovery measures to be taken for handling each failure is calculated by adding the calculated urgency, the importance of the system 6 configured from the service server 7 in which the failure has occurred, and the elapsed time coefficient calculated based on the elapsed time from the occurrence of the failure.

Thus, according to the information processing system 1, if a failure occurs in a service server 7 configuring the system 6 being used by numerous customers, since the influence of such failure is immediately reflected in the urgency and the priority of the recovery measures to be taken for handling such failure is calculated higher in accordance therewith, the objective urgency and priority of the failure that occurred in the system 6 can be promptly presented to the maintenance worker 11. Consequently, according to the information processing system 1, maintenance work can be optimized.

### (6) Other Embodiments

Note that, while the embodiment described above explained a case of configuring the failure handling support system 8 with the external connection server 9 and the monitoring server 10, the present invention is not limited thereto, and the failure handling support system 8 may also be configured only with the external connection server 9 by installing all functions of the monitoring server 10 in the external connection server 9.

Moreover, while the embodiment described above explained a case of installing all functions; namely, the status monitoring function of monitoring the status of each service server 7 to be monitored in the data center 4, the urgency calculation function of calculating the urgency of the recovery measures to be taken for handling each of the detected failures, the priority determination function of determining the priority of the recovery measures to be taken for handling each failure, and the determination result presentation function of presenting to the maintenance worker 11 the determined priority of the recovery measures to be taken for handling each failure in a single monitoring server 10, the present invention is not limited thereto, and these functions may be distributed and installed in a plurality of computer devices configuring a distributed computing system.

Furthermore, while the embodiment described above explained a case of calculating the priority for each service server 7 in which a failure occurred by combining the urgency calculated for such service server 7, importance of the system 6 and the elapsed time coefficient, the present invention is not limited thereto, and the priority may also be calculated by multiplying the urgency, importance of the system 6 and elapsed time coefficient, and, as the method of calculating the priority, various other types of calculation methods can be broadly applied. Here, the priority may also be calculated so that the number of accesses from the customer terminal 3 to the service server 7 from the occurrence of a failure in such service server 7 up until now will have a greater influence.

Furthermore, while the embodiment described above explained a case of calculating the urgency of the failure based only on whether there has been any access from users from the occurrence of the failure up until now, the present invention is not limited thereto, and the monitoring server 10 may calculate the urgency so that the urgency will be higher as the number of accesses is greater based on the number of accesses from users from the occurrence of the failure up until now. Since the urgency and priority of the failure that occurred in the service server 7 that is frequently used by the customers will be calculated to be high as a result of adopting the foregoing configuration, the urgency and priority which promptly and objectively reflect the actual status of use of each service server 7 by the customers can be presented to the maintenance worker 11. Consequently, according to the information processing system 1, maintenance work can be further optimized.

Note that, in the foregoing case, in substitute for “user influence” in the urgency table 52, for instance, items in which “number of accesses” is divided into several ranges, such as number of accesses 1 to 10″ and “number of accesses 11 to 100”, may each be used as a point-addition item, and, for example, the urgency score may be set to be higher as the number of accesses is greater, such as by setting the urgency score of “number of accesses 1 to 10” to “1”, setting the urgency score of “number of accesses 11 to 100” to “2”, . . . . . . Subsequently, the corresponding urgency score may be added with the number of error logs detected in step S82 as the “number of accesses” in step S84 of the urgency calculation processing described above with reference to FIG. 17A and FIG. 17B.

Furthermore, while the embodiment described above explained a case where the importance is set in advance by the customer or the like, the present invention is not limited thereto, and, for example, the importance may also be dynamically decided based on the number of accesses from the customer for each system 6 in a steady state (total number of accesses from customers to each service server 7 configuring the system 6 in a steady state). Specifically, a value obtained by directly normalizing the number of accesses from customers in a given period may be used as the importance, or the importance may be decided by using the number of accesses from customers for each system 6 in a steady state based on other methods.

### INDUSTRIAL APPLICABILITY

The present invention can be broadly applied, for example, to various failure handling support apparatuses that support the handling of failures by a maintenance worker to perform the maintenance and management of a service server in a data center.

### REFERENCE SIGNS LIST

1 . . . information processing system, 3 . . . customer terminal, 4 . . . data center, 5 . . . maintenance worker terminal, 6 . . . system, 7 . . . service server, 8 . . . failure handling support system, 9 . . . external connection server, 10 . . . monitoring server, 11 . . . maintenance worker, 23, 27 . . . processor, 40 . . . performance monitoring agent program, 41 . . . access monitoring unit, 42 . . . network monitoring unit, 43 . . . access history table, 44 . . . network monitoring table, 45 . . . response threshold table, 46 . . . performance monitoring manager program, 47 . . . status monitoring unit, 48 . . . urgency calculation unit, 49 . . . priority determination unit, 50 . . . determination result presentation unit, 51 . . . failure management table, 52 . . . urgency table, 53 . . . importance table, 54 configuration management table, 55 . . . maintenance hours table, 56 . . . setting table, 60 . . . failure occurrence status list screen, 61 . . . failure occurrence status list.

1. A failure handling support apparatus which supports failure handling by a maintenance worker, comprising:
a status monitoring unit which performs status monitoring of a network and server devices;
an urgency calculation unit which calculates, when the status monitoring unit detects a failure, an urgency of handling the failure based on whether there has been any access from a user from an occurrence of the failure up until now;
a priority determination unit which determines a priority of the failure based on the urgency calculated by the urgency calculation unit; and
a determination result presentation unit which presents a determination result of the priority determination unit to the maintenance worker.

2. The failure handling support apparatus according to claim 1, wherein:
the urgency calculation unit calculates the urgency based on whether a recovery from the failure has been achieved and whether switching to a standby system has been performed in addition to whether there has been any access from a user from an occurrence of the failure up until now; and
the priority determination unit calculates the priority based on an elapsed time from the failure and an importance of a system configured from one or more of the server devices that will be influenced by the failure in addition to the urgency.

3. The failure handling support apparatus according to claim 1, wherein:
the determination result presentation unit presents to the maintenance worker the determination result of the priority determination unit in order from the failure with the highest priority and, for the failures having the same priority, in order from a greatest number of accesses from the user.

4. The failure handling support apparatus according to claim 2, wherein:
the importance is set by the user in advance, or decided dynamically based on a number of accesses from a customer for each of the systems in a steady state.

5. The failure handling support apparatus according to claim 1, wherein:
the urgency calculation unit, in addition to whether there has been any access from a user from an occurrence of the failure up until now, calculates the urgency of handling the failure based on the number of the accesses.

6. A failure handling support method to be executed by a failure handling support apparatus which supports failure handling by a maintenance worker, comprising:
a first step of performing status monitoring of a network and server devices;
a second step of calculating, when a failure is detected in the status monitoring, an urgency of handling the failure based on whether there has been any access from a user from an occurrence of the failure up until now;
a third step of determining a priority of the failure based on the calculated urgency; and
a fourth step of presenting a determination result of the priority to the maintenance worker.

7. The failure handling support method according to claim 6, wherein:
in the second step, the failure handling support apparatus calculates the urgency based on whether a recovery from the failure has been achieved and whether switching to a standby system has been performed in addition to whether there has been any access from a user from an occurrence of the failure up until now; and
in the third step, the failure handling support apparatus calculates the priority based on an elapsed time from the failure and an importance of a system configured from one or more of the server devices that will be influenced by the failure in addition to the urgency.

8. The failure handling support method according to claim 6, wherein:
in the fourth step, the failure handling support apparatus presents to the maintenance worker the determination result of the priority in order from the failure with the highest priority and, for the failures having the same priority, in order from a greatest number of accesses from the user.

9. The failure handling support method according to claim 7, wherein:
the importance is set by the user in advance, or decided dynamically based on a number of accesses from a customer for each of the systems in a steady state.

10. The failure handling support method according to claim 6, wherein:
in the second step, the failure handling support apparatus, in addition to whether there has been any access from a user from an occurrence of the failure up until now, calculates the urgency of handling the failure based on the number of the accesses.
